(19) United States
(12) Patent Application Publication
(10) Pub. No.: US 2022/0252705 A1
(43) Pub. Date: Aug. 11, 2022

(54) Lidar Authentication

(71) Applicant: OSRAM GmbH, Muenchen (DE)

(72) Inventors: Bernhard Siessegger, Unterschleissheim (DE); Gerhard Maierbacher, Munchen (DE)

(21) Appl. No.: 17/650,347

(22) Filed: Feb. 8, 2022

(30) Foreign Application Priority Data
Feb. 9, 2021 (DE) 102021103007.2

(51) Int. Cl. G01S 7/4913; G01S 7/484; G01S 7/497; G01S 17/88

(52) U.S. Cl. CPC G01S 7/4913; G01S 17/88; G01S 7/497; G01S 7/484

(57) ABSTRACT

In an embodiment a LIDAR device includes a processing circuit configured to receive a request for a software modification of the LIDAR device and authenticate the request for the software modification via an exchange of authentication data over a standard communication interface and an optical communication interface, wherein the optical communication interface is provided by an optoelectronic component of the LIDAR device.

### CROSS-REFERENCE TO RELATED APPLICATIONS

This application claims the priority of German Application No. 10 2021 103 007.2, filed on Feb. 9, 2021, which application is hereby incorporated herein by reference.

### TECHNICAL FIELD

Various embodiments are related to a LIDAR (“Light Detection and Ranging”) device and methods thereof (e.g., a method of authenticating a request for software modification in a LIDAR device).

### BACKGROUND

Light detection and ranging is a sensing technique that is used, for example, in the field of autonomous driving for providing detailed information about the surrounding of an automated or partially automated vehicle. Light is used to scan a scene and determine the properties (e.g., the location, the speed, the direction of motion, and the like) of the objects present therein. A LIDAR system typically uses the time-of-flight (ToF) of the emitted light to measure the distance to an object. LIDAR modules and systems are functional safety-critical components, for example in modern automobiles. Parameter modifications or software updates both potentially impacting the operations of such a module or system need to be performed very cautiously to prevent non-legitimate attempts of interfering with their proper functioning.

### SUMMARY

Various embodiments are related to an authentication strategy for deciding whether to authorize or reject a request for software modification received at a LIDAR device. The strategy described herein is based on exchanging authentication data via at least two different types of communication interfaces (illustratively, separate and independent from one another), which include at least one communication interface provided (e.g., defined) by an optoelectronic component (e.g., a light source and/or a sensing element) of the LIDAR device, and include a standard interface (also referred to herein as conventional interface or default interface) based on wired or radio-based wireless communication. The strategy described herein makes use of the architecture of a LIDAR device to introduce an additional layer of security in relation to parameter modification and software updates. By way of illustration, the authentication strategy described herein may be understood as a “two-factor authentication” or as a “two-interfaces authentication” for software modifications in a LIDAR device.

The term “software modification” as used herein may describe a change in the operation of a device (e.g., a module, or a component) that does not involve alterations of the hardware parts of the device. A “software modification” may include a change in one or more operational parameters of the device, such as a power of an emitted signal (e.g., a peak power of an emitted light pulse), a duration of an emitted signal (e.g., a duration of an emitted light pulse), an oscillation frequency of a mirror, a rate of acquisition of images, a location for storing acquired images, etc. Illustratively, a “software modification” may include a change in one or more parameters that control (e.g., define) how the hardware parts of that device operate or should operate. Additionally or alternatively, a “software modification” may include a software update, e.g. an update of a firmware of the device, for example including a newer version of the firmware. A “software modification” may also be referred to herein as “critical software modification” to indicate the potentially safety-relevant impact that the modification may have.

In general, there may be legitimate reasons for critical software modifications. A legitimate reason may be, for example, a recall campaign by the LIDAR module manufacturer or the car's original equipment manufacturer (OEM), e.g. to fix product bugs, enabling compliance with new regulations, etc. As another example, a critical software modification may include an upgrade by the module manufacturer or OEM in order to increase module or system performance, and/or to enable new features and functionalities.

However, there may also be non-legitimate reasons for critical software modifications. For example, a critical software modification may include a risky increase of the product performance, e.g. by so-called “chip tuners”, partially or fully disabling derating functionality in order to prevent thermal overheating or other lifetime diminishing operations, or even turning the product into being not compliant with safety regulations (e.g., with eye safety regulations). As another example, a critical software modification may be related to an attempt to blackmail the product manufacturer or OEM, with the threat that non-safety compliant or even malicious LIDAR devices (e.g., providing fake object information, shooting laser light at pedestrians, etc.) would cause harm to the respective companies and asking for ransom in order to roll-back the respective software update.

There may be several ways on how a firmware may be accessed for a non-legitimate software modification. An option may be hacking the wireless communication to the car triggering a “remote upgrade” (also referred to herein as remote update). A remote update service of a car may be restricted via certification and authentication methods to authorize critical software modifications, which however may be not immune to cyber-attacks. A second option may be obtaining physical access to the car's internal communication bus which controls the LIDAR device (e.g., via a diagnosis connector). A third option may be obtaining physical access to the device itself (e.g., to the connector of the communication bus or the integrated circuits or microcontroller holding the relevant software). The third option for getting access requires however significant effort and is not suitable for large scale attacks.

Another problem increasingly faced in the market is the proliferation of counterfeit products. In particular, in automotive aftermarket and non-automotive markets (e.g., professional, industrial, or consumer markets) counterfeit products find their way into the market through distribution channels. Conventional measures against counterfeit products may include the use of serial numbers, which may be printed on stickers or on the product itself. These numbers need to be manually read and entered into verification tools or websites, thus providing a cumbersome and error-prone way of determining the authenticity of a product.

Various embodiments described herein are related to an adapted approach for handling requests for software modifications, which is based on using the transmission capabilities of a LIDAR device to provide one or more additional communication channels for the exchange of critical data (illustratively, additional with respect to standard communication channels). The additional communication channel(s) may reduce or prevent the risk of non-legitimate software modifications, e.g. by introducing a communication path that cannot be hacked from a remote location.

Various embodiments described herein are related to using the transmission capabilities of a LIDAR device to provide information about the LIDAR device, e.g. to transmit the information to a service station external to the LIDAR device. The information provided may include data identifying the device, which may be used to determine its authenticity. Illustratively, various embodiments may be related to a strategy for identifying counterfeit spare parts and products, which may be implemented, for example, by car dealers and garages (in case of automotive), equipment repair and maintenance shops, or even end-customers.

According to various embodiments, a method of authenticating a request for a software modification of a LIDAR device may include: receiving a request for a software modification of the LIDAR device; and authenticating the request for software modification via an exchange of authentication data over a standard communication interface and an optical communication interface, the optical communication interface being provided by an optoelectronic component of the LIDAR device.

According to various embodiments, a method of determining the authenticity of a LIDAR device may include: transmitting information about the LIDAR device via an optical communication interface, the optical communication interface being provided by an optoelectronic component of the LIDAR device; and comparing the transmitted information with stored information about the LIDAR device.

According to various embodiments, a LIDAR device may include: a processing circuit configured to: receive a request for a software modification of the LIDAR device; and authenticate the request for software modification via an exchange of authentication data over a standard communication interface and an optical communication interface, the optical communication interface being provided by an optoelectronic component of the LIDAR device.

According to various embodiments, a LIDAR device may include: an optoelectronic component configured to emit a light signal; and a processing circuit configured to: receive a request for a software modification of the LIDAR device; and authenticate the request for software modification via an exchange of authentication data over a standard communication interface and an optical communication interface, the optical communication interface being defined by the optoelectronic component.

According to various embodiments, a LIDAR device may include: an optoelectronic component configured to emit a light signal; and a processing circuit configured to: encode information about the LIDAR device; transmit an instruction to the optoelectronic component to emit the light signal in accordance with the encoded information; and receive a response representative of an authenticity of the LIDAR device in accordance with the emitted information.

In case the LIDAR device is mounted in a vehicle, the approach described herein may provide that critical software modifications only happen while the vehicle is stationary (in case a wired communication interface is used), preventing updates while the vehicle is in motion, thus increasing the security of the software modification process. The use of an optical communication channel may prevent any attacks that rely only on a conventional wireless communication channel or on conventional wired access (e.g., on the car-internal communication bus), thus reducing the risk of malicious attacks. In addition, the use of an optical communication channel may ensure that the exchange of data can occur only in case the entity transmitting the optical signal and the entity receiving the optical signal are in close proximity with one another (illustratively, the two entities are within the respective transmission range and reception range, for example a few meters). Thus, a software modification may be authenticated (and performed) only in case the LIDAR device is close (e.g., within 10 m, or within 5 m, only as examples) to the entity issuing the request (e.g., a service system, for example of a trusted garage), preventing non-legitimate attacks by remotely-located hackers. The automatic verification that a product is a genuine product may be performed on a regular basis, e.g. whenever a critical software modification is performed, thus providing a periodic monitoring that ensures a secure operation of the system.

The terms “interface” and “channel” may be used herein in connection to the communication capabilities of an entity (e.g., a LIDAR device, a service system, etc.). An “interface” may be understood as the components (e.g., the circuitry) that enables the communication, e.g. the transmission and/or the reception of information. A “channel” may describe how the information is transmitted and/or received, e.g. in which way the information is communicated. The terms “interface” and “channel” may be in a relationship with one another, in that the type of interface defines the type of channel, and vice versa. In the present description, any reference to a “communication interface” may be understood as including a corresponding “communication channel”, and any reference to a “communication channel” may be understood as including a corresponding “communication interface”.

The terms “standard communication interface” or “standard communication channel” may be used herein to describe conventionally used types of communication between two (or more) entities (e.g., between a LIDAR device and a service station). A “standard communication interface” may include, for example, a wired communication interface, e.g. transmission of data over a wire-based (cable-based) communication technology, e.g. in accordance with a communication protocol suitable for wired connections. A wired communication interface may include, for example, a copper-based connection between two entities communicating with one another, or a fiber-based connection between two entities communicating with one another. As another example, a “standard communication interface” may include, a wireless communication interface based on radio waves, e.g. in accordance with communication standards, such as IEEE 802.11 standards. Analogously, a “standard communication channel” may include, as examples, a wired communication channel or a radio-based wireless communication channel. A “standard communication interface (or channel)” may also be referred to herein as “primary communication interface (or channel)”.

In the context of the present description reference may be made to an optical communication interface (or to an optical communication channel) to describe a type of communication additional and alternative to a standard communication interface. The optical communication interface may be understood as an out-of-band (secondary) communication interface separate from a primary communication interface. It is understood that an optical communication interface is an example of such separate communication interface, and other types of communication may be provided, for example based on the transmission and/or reception of acoustic waves (e.g., ultrasonic waves).

In some embodiments, the separate optical communication interface or channel may be provided (e.g., defined) by an optoelectronic component of a LIDAR device. An optoelectronic component providing an optical communication interface may be understood as the communication being carried out via a signal (e.g., a light signal) emitted by the optoelectronic component and/or via a signal received (in other words, detected) by the optoelectronic component. Illustratively, the optoelectronic component may enable one-directional communication (in case it includes, or uses, only emitting capabilities or detection capabilities) or bi-directional communication (in case it includes both emitting capabilities and detection capabilities). A signal emitted and/or received may be adapted (in addition or in alternative to the normal operation to which the signal is dedicated, e.g. in addition to ranging) to encode therein data that may be transmitted and/or received via the optical communication interface. The properties of the optical communication interface may be associated with the properties of the optoelectronic component, e.g. range, field of view, and the like. The optical communication interface as described herein may be distinct from a wired communication interface and from a radio-based wireless communication interface.

The use of an optoelectronic component to provide a communication interface may provide a simple and cost-effective solution for defining an additional (optical) communication channel, compared to other types of implementations based on wireless communication like Bluetooth, near-field communication (NFC), or an additional programming interface. These other implementations require additional dedicated hardware, thus increasing the overall cost of the system.

The term “LIDAR device” may be used herein to describe a device configured for LIDAR applications. A “LIDAR device” as used herein may be or may include a LIDAR module (illustratively, a module configured to carry out monitoring of a scene based on a LIDAR approach) or a LIDAR component (for example, a component of a LIDAR module). A “module” may be understood as an entity including a plurality of parts (e.g., a plurality of components) that together define the function of the module. Illustratively, a module may be understood as an entity configured to carry out a complex function that requires the contribution of a plurality of parts interacting together. A “component” may be understood as a single part that individually contributes to the operation of a larger entity (e.g., of a module). A component may be understood as a single part configured to carry out a simple (e.g., general purpose) function, e.g. with a limited scope. As an example, a component may be or may include an intelligent component, such as for example a component plus from OSRAM Opto Semiconductors (e.g., the next generation of the PLPVDC 940_P_L01, the “first intelligent 3D Sensing Emitter Module”, a vertical-cavity surface-emitting laser (VCSEL) device for Time-of-Flight (ToF) measurements in handheld devices). A component may itself include a plurality of components (sub-components, or elements) that provide the simple function of the component. The adapted authentication strategy described herein may be applicable to modules (e.g., LIDAR modules, for example from OSRAM automotive) and components (e.g., component plus, for example from OSRAM Opto Semiconductors), as described in further detail below. A LIDAR device may also be referred to herein as “LIDAR product” or simply as “product”.

In the context of the present description, reference may be made to a LIDAR module. A LIDAR module may include various components and sensors for monitoring a scene (e.g., an environment surrounding a vehicle), as commonly known in the art. By way of example, a LIDAR module may include a brightness sensor, a presence sensor, an optical camera, a RADAR sensing system, an ultrasonic sensing system, and/or a light-based sensing system. A LIDAR module may include one or more actuators for adjusting the environmental surveillance conditions, e.g. one or more actuators for adapting the emission direction of light, for adapting the orientation of an optical camera, for adapting the emission direction of ultrasonic waves, and the like. A LIDAR module may include a data processing circuit for processing the data provided by the sensors. The data processing circuit may include, for example, a sensor fusion module for combining the data provided by different types of sensors and enhancing the monitoring of the scene. The data processing circuit may be configured to carry out object recognition, object tracking, and/or object classification to analyze the object(s) present in the monitored scene. The object recognition, object tracking, and/or object classification may be based on the data provided by the sensors (e.g., by one or more of the available sensors). A LIDAR module may include one or more memory devices storing information and instructions, such as the sensed data, the determined object information, instructions on how to operate the sensors, and the like. A LIDAR module may include one or more communication interfaces to communicate with other systems or modules (e.g., other modules of a same vehicle, or another LIDAR module of another vehicle, as examples), e.g. configured for wired- and/or conventional radio-based wireless communication. A LIDAR module may be part, for example, of a vehicle or of a smart farming or of an indoor monitoring system.

It is understood that a LIDAR device is an example of a possible application of the adapted authentication strategy described herein. The adapted authentication strategy may be implemented in any device capable of communicating data via an out-of-band communication interface, e.g. in any device capable of optically communicating data. Illustratively, the adapted authentication strategy may be implemented by using components that are already present in a device (e.g., a light source, a detector, etc.), e.g. components already provided for another type of operation, such as for sensing, that may additionally take part in the authentication of a request for software modification.

Furthermore, reference may be made to implementations for automotive applications (e.g., in case the LIDAR device is installed or to be installed in a vehicle). The approach described herein may provide an operation with greater security in automotive aftermarket. It is however understood that the applications of a LIDAR device are not limited to the automotive context, and a LIDAR device may be applied in other applications and markets such as professional, industrial, consumer, etc.

The expression “signal feature” may be used herein to describe a characteristic element of a signal (e.g., of a sensing signal, or of a sensed signal), for example a peak, a valley, a pulse (e.g., a light pulse, a current pulse, a voltage pulse, etc.), a sequence of pulses (e.g., a sequence of light pulses, of current pulses, of voltage pulses, etc.), a plateau, and the like.

The term “amplitude” may be used herein to describe the height of a peak, e.g. the height of a pulse. The term “amplitude” may describe the signal level of a signal at the peak with respect to a reference value for the signal level. The term “amplitude” may be used herein also in relation to a signal that is not a symmetric periodic wave, e.g. also in relation to an asymmetric wave (for example in relation to a signal including periodic pulses in one direction). In this regard, the term “amplitude” may be understood to describe the amplitude of the signal (e.g., of the peak) as measured from the reference value of the signal level.

The term “processor” as used herein may be understood as any kind of technological entity that allows handling of data. The data may be handled according to one or more specific functions executed by the processor. Further, a processor as used herein may be understood as any kind of circuit, e.g., any kind of analog or digital circuit. A processor may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. Any other kind of implementation of the respective functions, which will be described below in further detail, may also be understood as a processor or logic circuit. It is understood that any two (or more) of the processors or logic circuits detailed herein may be realized as a single entity with equivalent functionality or the like, and conversely that any single processor or logic circuit detailed herein may be realized as two (or more) separate entities with equivalent functionality or the like.

The term “generate” as used herein encompasses both ‘direct’ generation via a mathematical expression/formula/relationship and ‘indirect’ generation via lookup or hash tables and other array indexing or searching operations.

### BRIEF DESCRIPTION OF THE DRAWINGS

In the drawings, like reference characters generally refer to the same parts throughout the different views. The drawings are not necessarily to scale, emphasis instead generally being placed upon illustrating the principles disclosed herein. In the following description, various embodiments disclosed herein are described with reference to the following drawings, in which:

FIG. 1 shows schematically a LIDAR device according to various embodiment;

FIG. 2A, FIG. 2B, and FIG. 2C each shows schematically an optoelectronic component according to various embodiments;

FIG. 3 shows schematically a service system according to various embodiments;

FIG. 4 shows schematically a system including a LIDAR device and a service system according to various embodiments;

FIG. 5 shows schematically a system including a LIDAR device and a service system according to various embodiments;

FIG. 6A shows schematically a LIDAR device according to various embodiments;

FIG. 6B shows schematically an exchange of authentication data according to various embodiments;

FIG. 6C shows schematically an exchange of authentication data according to various embodiments;

FIG. 7 shows a schematic flow diagram of a method of authenticating a request for software modification according to various embodiments; and

FIG. 8 shows schematically a LIDAR device according to various embodiments.

### DETAILED DESCRIPTION OF ILLUSTRATIVE EMBODIMENTS

The following detailed description refers to the accompanying drawings that show, by way of illustration, specific details and implementations in which the embodiments disclosed herein may be practiced. These embodiments are described in sufficient detail to enable those skilled in the art to practice the disclosed implementations. Other embodiments may be utilized and structural, logical, and electrical changes may be made without departing from the scope of the disclosed implementations. The various embodiments are not necessarily mutually exclusive, as some embodiments may be combined with one or more other embodiments to form new embodiments. Various embodiments are described in connection with methods and various embodiments are described in connection with devices (e.g., a LIDAR device, a processing circuit, an optoelectronic component, etc.). However, it is understood that embodiments described in connection with methods may similarly apply to the devices, and vice versa.

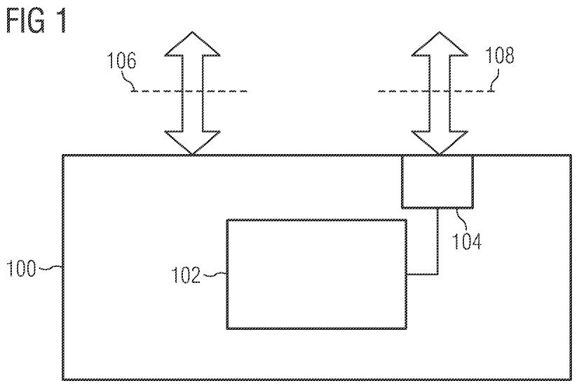

FIG. 1 shows a schematic diagram of a LIDAR device 100 according to various embodiments. As described above, the LIDAR device 100 may be or may include a LIDAR module or a LIDAR component. It is understood that the representation in FIG. 1 may be simplified for the purpose of explanation, and the LIDAR device 100 may include additional elements with respect to those shown. In some embodiments, a vehicle (e.g., a car, for example a car capable of at least partially autonomous driving) may include one or more LIDAR devices 100.

The LIDAR device 100 may include a processing circuit 102. The processing circuit 102 may be configured to control an operation of the LIDAR device 100. The processing circuit 102 may include one or more processors and/or one or more sub-modules assigned to a respective function. The one or more processors and/or sub-modules of the processing circuit 102 may be connected with one another via a communication bus. Illustratively, the processing circuit 102 may include one or more communication buses, each connected to respective processors and/or sub-modules, to enable internal exchange of information.

As an example, the processing circuit 102 may include a storage module, e.g., a memory, for example one or more registers, storing instructions for an operation of the LIDAR device 100, and/or data received (and/or detected) at the LIDAR device 100. As another example, the processing circuit 102 may include one or more processors configured to carry out processing and management of information (e.g., data) for the LIDAR device 100. It is understood that the processing circuit 102 may include additional, less, or alternative processors and/or sub-modules with respect to those described herein contributing to control the operation of the LIDAR device 100.

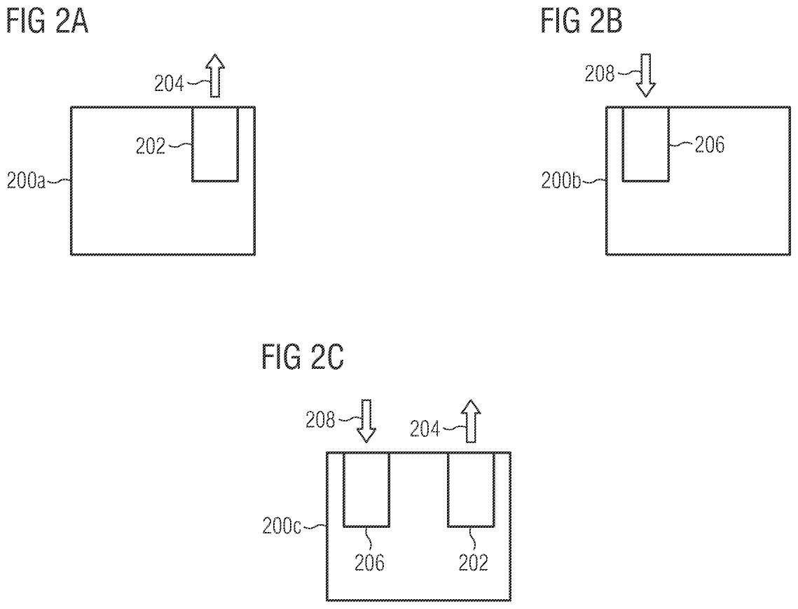

The LIDAR device 100 may include an optoelectronic component 104 configured for light emission and/or light detection. An optoelectronic component (e.g., the optoelectronic component 104) will be described in further detail in relation to FIG. 2A, FIG. 2B, and FIG. 2C. Briefly, the optoelectronic component 104 may be configured to emit a light signal (in other words, an optical signal), and/or may be configured to detect a light signal.

The processing circuit 102 may be configured to control an operation of the optoelectronic component 104, e.g. to provide instructions to the optoelectronic component 104 to control the emission of the light signal and/or to provide instructions to the optoelectronic component 104 to control the detection of a light signal. Illustratively, the processing circuit 102 and the optoelectronic component 104 may be connected with one another to exchange data (e.g., instructions, sensed data, etc.).

The LIDAR device 100 (e.g., the processing circuit 102) may be configured to exchange (e.g., to transmit and/or receive) data with an external device or system via a standard communication interface 106 and an optical communication interface 108. Illustratively, the LIDAR device 100 may include a standard communication interface 106 (e.g., components providing the standard communication interface 106) and an optical communication interface 108 (e.g., components providing the optical communication interface 108).

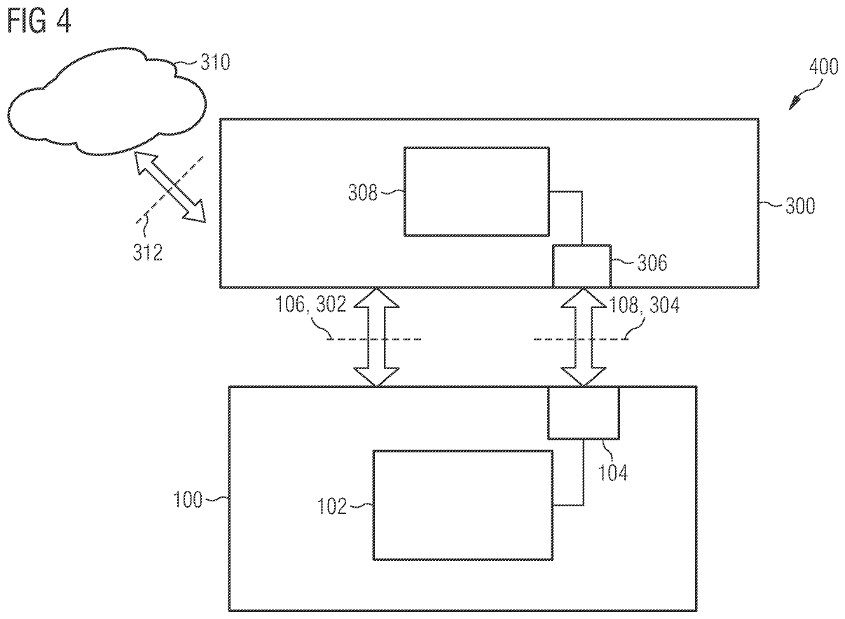

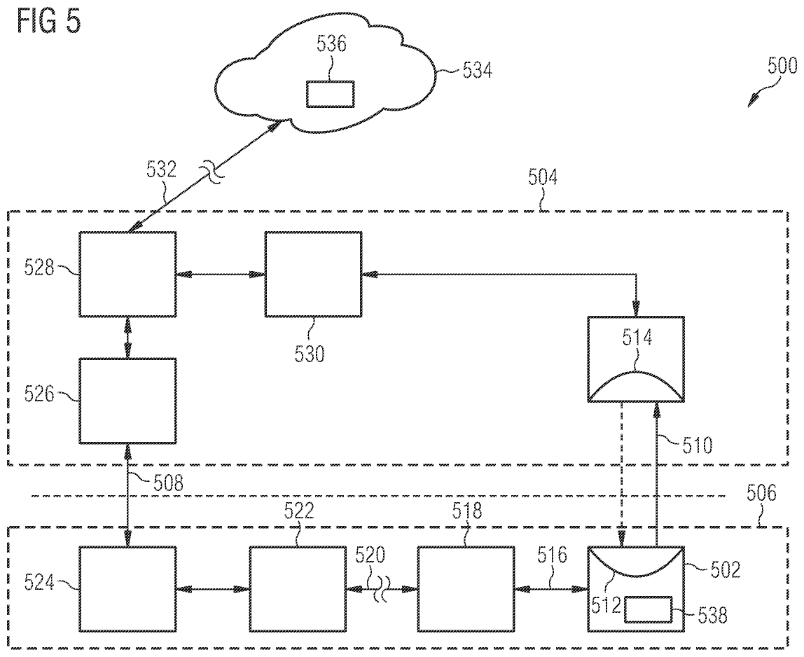

The standard communication interface 106 may be configured to connect the LIDAR device 100 and the external device or system. For example, the standard communication interface 106 may include a wired connection (illustratively, a wired communication channel) between the LIDAR device 100 and the external device or system, e.g. between the LIDAR device 100 and another system (see FIG. 4 and FIG. 5), for example another system issuing a request for software modification as described in further detail below. In some embodiments, the standard communication interface 106 may include a wire (in other words, a cable) configured to connect the LIDAR device 100 (e.g., the processing circuit 102) to the external device or system. As another example, the standard communication interface 106 may include a radio-based wireless connection (illustratively, a wireless communication channel), as known in the art, connecting the LIDAR device 100 and the external device or system (e.g., connecting the LIDAR device 100 and the other system, for example via a network). The standard communication interface 106 may be a bi-directional communication interface via which the LIDAR device 100 (e.g., the processing circuit 102) may receive and transmit data. The standard communication interface 106 may be a primary communication interface of the LIDAR device 100.

In some embodiments, the standard communication interface 106 may include additional devices (e.g., additional modules) along the path connecting the LIDAR device 100 and the external device or system (e.g., in case of a wired communication interface). Illustratively, the standard communication interface 106 may be an “indirect” interface between the LIDAR device 100 and the external device or system, e.g. the external device or system may be connected via the standard communication interface 106 to a module (an interface module) which is then connected to the LIDAR device 100 (e.g., via a communication bus). The additional devices along the path may include, as an example, one or more modules of a system in which the LIDAR device 100 is installed (see FIG. 5), e.g. one or more modules of a vehicle. The one or more modules and the LIDAR device 100 may be connected to one another, e.g. may be connected to a (common) communication bus. The (optionally present) other devices do not alter the functionality of the standard communication interface 106 providing a (e.g., wired) connection between the LIDAR device 100 and the external device or system.

The optical communication interface 108 may be provided (e.g., defined) by the optoelectronic component 104 of the LIDAR device 100, as described in further detail in relation to FIG. 2A to FIG. 2C. Briefly, the optoelectronic component 104 may be configured (e.g., controlled) to emit a light signal that may include data encoded therein. Additionally or alternatively, the optoelectronic component 104 may be configured to provide a received signal (illustratively, may be configured to detect a light signal) that may include data encoded therein. The optoelectronic component 104 may be configured to enable one-directional or bi-directional communication via the emission and/or detection of encoded light signals.

The use of an optoelectronic component 104 for providing an optical communication interface may provide that the communication occurs under “line of sight conditions”, illustratively communication may occur only in case the optoelectronic component 104 may see another system (e.g., towards which the encoded light signal is emitted and/or from which an encoded light signal is received), see FIG. 4 and FIG. 5. The optical communication interface 108 may thus enable communication over a limited range, e.g. less than 2 m, or less than 5 m, or less than 10 m, as numerical examples. This may introduce an additional layer of security for the communication, preventing any interference from remote attackers. The optical communication interface 108 may also be referred to herein as secondary communication interface. It is understood that the LIDAR device 100 may include more than one optical communication interface 108, e.g. the LIDAR device 100 may include, in some embodiments, a plurality of optoelectronic components 104, each providing a respective optical communication interface.

The exchange of data via the standard communication interface 106 and/or via the optical communication interface 108 may provide that the LIDAR device 100 is capable of communicating with the external device or system in a more secure way as compared to the case where only the standard communication interface is used. In this context the optical communication interface 108 may be used as a second independent communication channel that cannot be eavesdropped, attacked, or hacked in a simple manner. The usage of the standard and the second independent communication channel may thus improve security.

FIG. 2A, FIG. 2B, and FIG. 2C show each an optoelectronic component 200a, 200b, 200c in a schematic view according to various embodiments. These optoelectronic components 200a, 200b, 200c may be an example of the optoelectronic component 104 (illustratively, the LIDAR device 100 may include one or more of the optoelectronic components 200a, 200b, 200c). It is understood that the representation of the optoelectronic components 200a, 200b, 200c may be simplified for the purpose of explanation, and the optoelectronic components 200a, 200b, 200c may include additional elements with respect to those shown (e.g., circuitry, emitter optics, receiver optics, and the like).

The optoelectronic component 200a, 200b, 200c may be configured with light emission capabilities (FIG. 2A), light detection capabilities (FIG. 2B), or both light emission and detection capabilities (FIG. 2C).

As shown, for example, in FIG. 2A the optoelectronic component 200a may include a light source 202 configured to emit light (a light signal 204, e.g. a light signal including one or more light pulses). The light source 202 may be configured to emit light having a predefined wavelength, for example in the visible range (e.g., from about 380 nm to about 700 nm), infra-red and/or near infra-red range (e.g., in the range from about 700 nm to about 5000 nm, for example in the range from about 860 nm to about 1600 nm, or for example at 905 nm or 1550 nm), or ultraviolet range (e.g., from about 100 nm to about 400 nm). Illustratively, the light source 202 may include at least one of an infrared light source, an ultraviolet light source, or a visible light source.

The light source 202 may be configured to emit light in a pulsed manner, for example the light source 202 may be configured to emit one or more light pulses (e.g., a sequence of light pulses). In some embodiments, the light source 202 may be or may include an optoelectronic light source (e.g., a laser source). As an example, the light source 202 may include one or more light emitting diodes. As another example the light source may include one or more laser diodes, e.g. one or more edge-emitting laser diodes or one or more vertical cavity surface emitting laser diodes. The light source 202 may be configured to emit one or more laser pulses, e.g. a sequence of laser pulses.

The transmission of information using the optoelectronic component 202a, illustratively using the emitted light signal 204, may be carried out by encoding data in the emitted light signal 204. The light source 202 may be configured to emit the light signal 204 with a modulation that encodes therein the information to be transmitted. Illustratively, the light source may be configured (e.g., controlled) to emit the light signal 204 including one or more signal features (e.g., one or more peaks, one or more valleys, a sequence of light pulses, etc.) that encode the information to be transmitted. As an example, the light signal 204 may include one or more light pulses that form a sequence configured to encode data (e.g., a light pulse in the sequence may be seen as a “logic 1”, and the absence of a light pulse in the sequence may be seen as a “logic 0”). As another example, the amplitude of the light signal 204 may be (continuously) modulated, and different amplitude levels (in other words, different amplitude values) may correspond to different information (e.g., a first amplitude level may correspond to a logic “0”, and a second amplitude level may correspond to a logic “1”).

The light source 202 may be modulated to emit the light signal encoding data therein. A modulation of a light source (e.g., of the light source 202) may be understood as the light source receiving a modulated current (or a modulated voltage), which provides the emission of a light signal having the desired modulation. Illustratively, the optical communication interface may be provided at least in part by a modulation of the light source 202 to provide (e.g., to emit) the (modulated) light signal 204.

The optoelectronic component 200a may be configured to receive an instruction (e.g., from a processing circuit, for example from the processing circuit 102) to emit the light signal 204 including encoded data. The instruction may include a modulation to impose on the light signal 204. The instruction may be, for example, a modulated current signal or voltage signal that includes a modulation corresponding to the modulation to be imposed onto the light signal 204. In some embodiments, the optoelectronic component 200a may include a driver (not shown), e.g. a laser driver, configured to convert the received instruction into a control over the light source 202 to emit the desired light signal 204. The optoelectronic component 200a may be configured (e.g., controlled) to transmit different types of information, as described in further detail below.

In some embodiments, as shown in FIG. 2B, the optoelectronic component 200b may include a sensing element 206. The sensing element 206 may be configured to provide a received light signal. The sensing element 206 may be configured to receive a light signal 208 and to provide an analog representation of the light signal received at the sensing element 206. Providing a received light signal may be understood as detecting (in other words, sensing) a light signal 208 and providing a representation of the detected light signal. As an example, the sensing element 206 may be configured to provide an analog signal (e.g., a current or a voltage) associated with the light signal 208 received at the sensing element 206, e.g. an analog signal representing the light signal 208 received at the sensing element 206 (e.g., in some embodiments, the received light signal may be understood as a current signal or voltage signal representing a light signal 208 received at the sensing element 206). In some embodiments, a received light signal may be provided as a representation that may be processed by a processing circuit (e.g., by the processing circuit 102). A received light signal may also be referred to herein as detected light signal. In some embodiments, the optoelectronic component 200b may include a plurality of sensing elements 206. In this configuration, the plurality of sensing elements 206 may form an array, e.g. a one-dimensional or two-dimensional array.

In some embodiments, the optoelectronic component 200b (e.g., the sensing element 206, or each sensing element 206) may include at least one photo diode. The at least one photo diode may be configured to generate an analog signal (e.g., a photo current) in response to a light signal 208 impinging onto the at least one photo diode. As examples, the photo diode may include at least one of a PIN photo diode, an avalanche photo diode (APD), a single photo avalanche diode, or a silicon photomultiplier. In some embodiments, the optoelectronic component 200b (e.g., the sensing element 206) may include an amplifier circuit (e.g., a transimpedance amplifier) configured to amplify the response signal generated by the sensing element 206 (e.g., the response signal generated by the at least one photo diode).

The reception of information using the optoelectronic component 200b, illustratively using the light signal 208 received at the sensing element 206, may be carried out by encoding data in the light signal 208 received at the sensing element 206 (e.g., as described above for the emitted light signal 204). The received light signal may be demodulated (e.g., by a processing circuit, e.g. the processing circuit 102) to decode the information carried by the light signal. Illustratively, the optical communication interface may be defined at least in part by a demodulation of the light signal 208 received at the sensing element 206.

In some embodiments, as shown in FIG. 2C, the optoelectronic component 200c may include both a light source 202 and a sensing element 206, to enable bi-directional communication via the emission and reception of light signals.

In some embodiments, the optoelectronic component 200a, 200b, 200c may be the component providing ranging functionalities in a LIDAR device (e.g., in the LIDAR device 100). Illustratively, the optoelectronic component 200a, 200b, 200c may be configured to provide measurement of the properties of the objects present in a scene (e.g., position, speed, direction of motion, etc.), and in addition may be configured to provide the optical communication functionalities. Ranging may include determining (e.g., measuring, calculating) a time-of-flight associated with a light signal emitted by the optoelectronic component 200a, 200c. A processing circuit of a LIDAR device (e.g., the processing circuit 102 of the LIDAR device 100) may be configured to determine a time-of-flight associated with a light signal emitted by the optoelectronic component 200a, 200c. The time-of-flight may describe or represent the time it takes the light signal to be emitted and reflected back towards the LIDAR device (e.g., towards the optoelectronic component 200b, 200c, e.g. towards the sensing element 206).

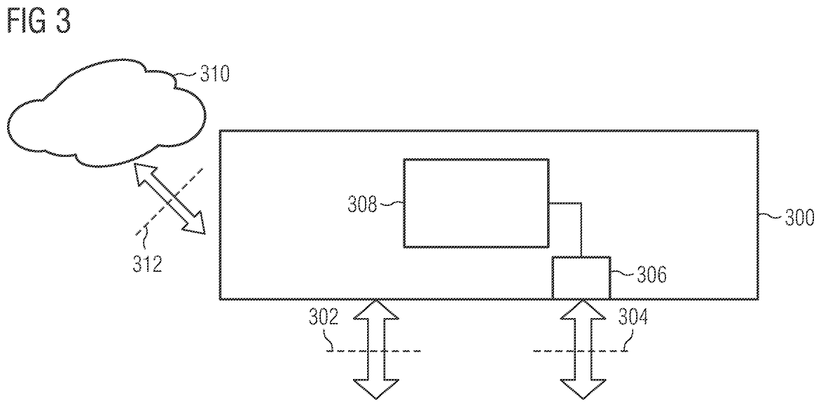

FIG. 3 shows a service system 300 in a schematic view according to various embodiments. The service system 300 may be configured to analyze (in other words, diagnose) the functioning of a LIDAR device (e.g., of the LIDAR device 100). The service system 300 may be understood as a testing system (or testing equipment) configured to test the functioning of a LIDAR device. In some embodiments, the service system 300 may be a testing system to test the functioning of a vehicle including a LIDAR device (e.g., including the LIDAR device 100). Only as an example, the service system 300 may be installed in a car wash, in a garage, or in a repair shop.

The service system 300 may be communication partner for a LIDAR device (e.g., for the LIDAR device 100), see also FIG. 4 and FIG. 5. Illustratively, the service system 300 may be configured for one-directional or bi-directional communication with a LIDAR device. The service system 300 may be configured to exchange data over a standard communication interface 302 (e.g., configured as the standard communication interface 106), and over an optical communication interface 304.

In some embodiments, the service system 300 may include an optoelectronic component 306 configured to provide the optical communication interface 304. The optoelectronic component 306 may be configured as the optoelectronic component 104, 200a, 200b, 200c described in relation to FIG. 1 to FIG. 2C. The optoelectronic component 306 may be configured to receive a light signal encoding data therein over the optical communication interface 304 (e.g., the optoelectronic component 306 may include a sensing element configured as the sensing element 206 described in relation to FIG. 2A to FIG. 2C). Additionally or alternatively, the optoelectronic component 306 may be configured to emit a light signal encoding data therein over the optical communication interface 304 (e.g., the optoelectronic component 306 may include a light source configured as the light source 202 described in relation to FIG. 2A to FIG. 2C).

In some embodiments, the service system 300 may include a LIDAR device (e.g., configured as the LIDAR device 100) configured to provide the transmission and/or reception of information over the optical communication interface 304.

The service system 300 may include a processing circuit 308 (e.g., one or more processors) configured to control an operation of the service system 300. The processing circuit 308 may be configured to process the data transmitted and/or received over the standard communication interface 302 and over the optical communication interface 304 (e.g., data transmitted to and/or received from a LIDAR device). The processing circuit 308 may be configured to control an operation of the optoelectronic component 306, as the processing circuit 102 and the optoelectronic component 104 described in relation to FIG. 1.

In some embodiments, the service system 300 may include (or have access to) a storage system 310. The storage system 310 may store information about the possible communication partners of the service system 300, e.g. information about LIDAR devices that may communicate with the service system (e.g., information about the LIDAR device 100).

The storage system 310 maybe, for example, a non-volatile memory of the service system 300, and the content of the non-volatile memory may be updated at regular intervals (e.g., every day, or every week, as examples) to ensure that the service system 300 has access to relevant and correct information. As another example (as shown in FIG. 3) the storage system 310 may be a cloud storage system to which the service 300 has access (e.g., over a network 312, e.g. over a secure network connection). The term “cloud” may be understood as commonly known in the art to indicate a decentralized storage system to which users may have access. The cloud storage system may belong to a trusted and reliable source, for example the manufacturer of the LIDAR device (e.g., the OEM of the LIDAR device loo), a trusted authority (e.g., the authority responsible for road safety), and the like. The service system 300 (e.g., the processing circuit 308) may be configured to communicate with the storage system 310 (e.g., over the network 312) to exchange information associated with a communication partner.

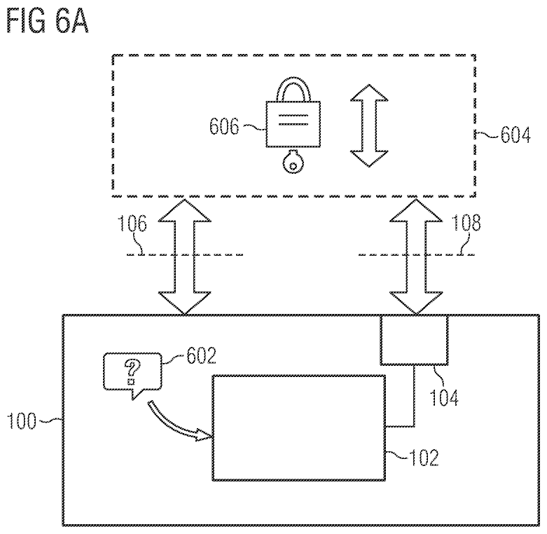

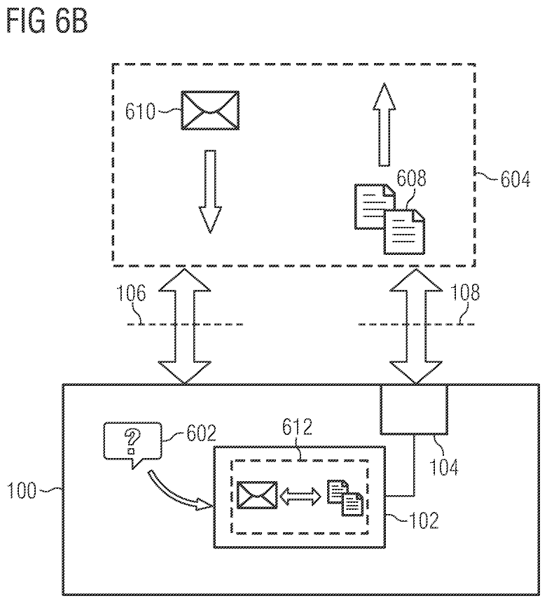

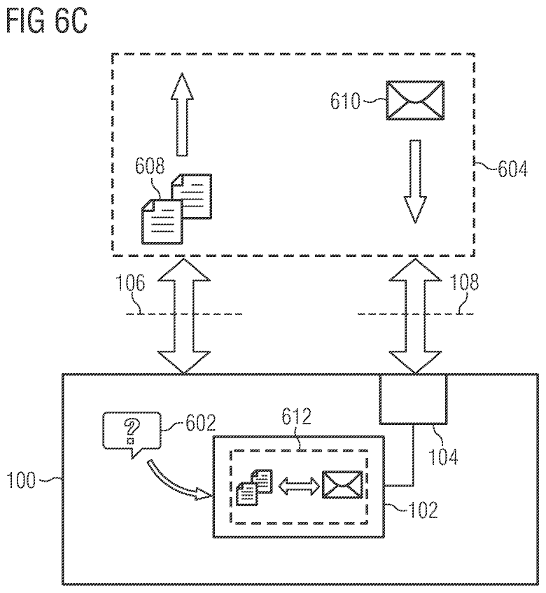

The information about a LIDAR device stored in the storage system 310 may include, for example, a serial number of the LIDAR device, lifetime information associated with the LIDAR device, geographical information associated with the LIDAR device, and/or predefined key information, as described in further detail below, e.g. in relation to FIG. 6A to FIG. 6C.

FIG. 4 shows a system 400 including the LIDAR device 100 and the service system 300 in a schematic view according to various embodiments.

The service system 300 and the LIDAR device 100 may be coupled to one another via the standard communication interface 106, 302 and the optical communication interface 108, 304. The service system 300 and the LIDAR device 100 may exchange data with one another over one or both of the standard communication interface 106, 302 and the optical communication interface 108, 304. The service system 300 may be configured to transmit data to the LIDAR device 100 and to receive data from the LIDAR device 100 via one or both of the standard communication interface 106, 302 and the optical communication interface 108, 304.

The coupling over the optical communication interface 108, 304 may be between the (first) optoelectronic component 104 of the LIDAR device 100 and the (second) optoelectronic component 306 of the service system 300, e.g. between a light source of the optoelectronic component 104 and a sensing element of the optoelectronic component 306 (and/or vice versa).

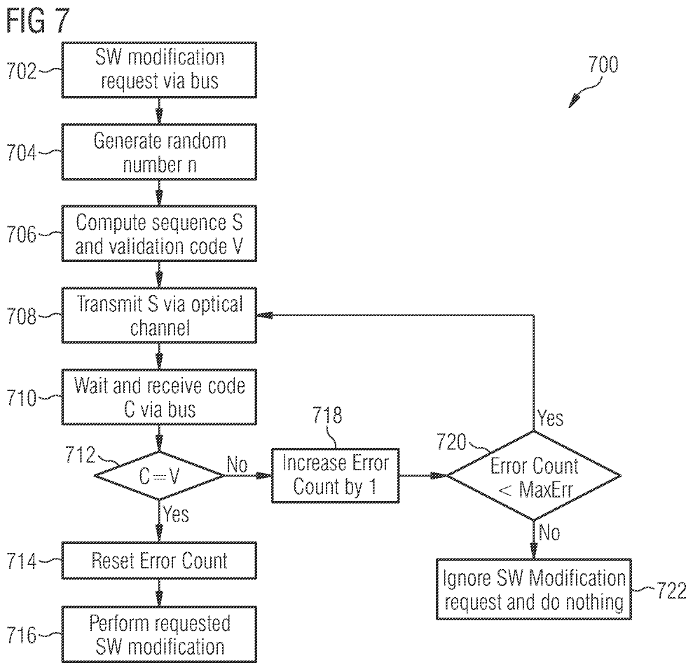

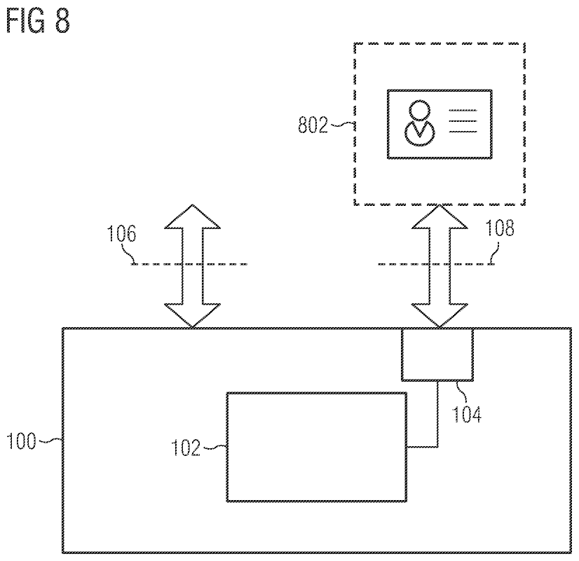

The interaction between the LIDAR device 100 and the service system 300, and possible applications of the exchange of data via the standard communication interface 106, 302 and/or via the optical communication interface 108, 304 will be described in relation to FIG. 6A, FIG. 6B, FIG. 6C, FIG. 7, and FIG. 8.

FIG. 5 shows a system 500 including a LIDAR device 502 and a service system 504 in a schematic view according to various embodiments. The system 500 may be an exemplary implementation of the system 400 described in FIG. 4. The LIDAR device 502 may be configured as the LIDAR device 100 described in relation to FIG. 1. The service system 504 may be configured as the service system 300 described in FIG. 3, illustratively the service system 504 may be an example of the service system 300 described in FIG. 3. The LIDAR device 502 may be part of a system 506, e.g. of a vehicle (such as a car with at least partially autonomous driving capabilities).

The LIDAR device 502 and the service system 504 may be coupled with one another over a standard communication interface 508 (e.g., configured as the standard communication interface 106, 302, for example a bi-directional wired communication interface) and over an optical communication interface 510 (e.g., configured as the optical communication interface 108, 304). The optical communication interface 510 may be one-directional or bi-directional. The coupling via the standard communication interface 508 may occur over a plurality of additional modules of the system 506, as described in further detail below.

As an exemplary scenario, FIG. 5 may illustrate the LIDAR device 502 (the product) in an overall automotive system, where the car 506 is coupled with an infrastructure 504 (a testing system) of a garage.

The LIDAR device 502 may include an optoelectronic component 512, and the service system 504 may include an optoelectronic component 514, e.g. configured as the optoelectronic component 104, 200a, 200b, 200c, 306 described in relation to FIG. 1 to FIG. 3. The optical communication interface 510 may be between the two optoelectronic components 512, 514. In some embodiments, the optoelectronic component 514 may be part of a LIDAR device of the service system 504, e.g. the service system 504 may include a (second) LIDAR device (configured as the LIDAR device 502) to establish the optical communication interface 510. Illustratively, the optoelectronic component 514 of the service system 504 may be understood as part of a LIDAR receiver service module. The use of identical LIDAR devices on both sides may conveniently eliminate additional hardware design effort, providing the re-utilization of already readily available products in the creation of the service setup.

The LIDAR device 502 and the service system 504 may include various modules to assist the communication and the exchange of data externally and internally to the LIDAR device 502 and the service system 504, as described in further detail below.

At the side of the system 506, the LIDAR device 502 (the product) may communicate over a wired bidirectional communication 516 with another (first) module 518 of the system 506. The module 518 may be connected with a wired communication bus 520. The wired communication bus 520 may be managed by a bus master (not shown).

Various (other) modules may be connected to the wired communication bus 520. For example, a (second) module 522, configured to act as a gateway/translator to allow a diagnosis interface module 526 of the service system 504 to talk with other components on the bus 520 (e.g., to talk with the first module 518).

The diagnosis interface module 526 may be configured to provide an interface for a diagnosis (e.g., a wired diagnosis), for example by a technician in a garage.

A (third) module 524 of the system 506 may communicate (illustratively, talk) with the respective counterpart 526 of the service system 504 (e.g., of the garage).

The diagnosis system of the service system 504 may be controlled by a processing circuit 528 (e.g., a computer). The computer 528 may also communicate with the optoelectronic component 514 (e.g., with the LIDAR receiver service module). The optoelectronic component 514 (the receiver module) may be configured to receive optical information from the LIDAR device 502 (the product). In case of a bi-directional optical communication also the other direction for the optical communication may be possible (the optoelectronic component 514 may be further understood as part of a LIDAR emitter service module). As direct line-of-sight between the two optoelectronic components 512, 514 (e.g., between the LIDAR device 502 and a LIDAR device of the service system 504) is needed for communication, and since the respective field of views may be typically relatively narrow (e.g., an angular field of view of less than 60°, or less than 45°), it is ensured by the law of physics that the system 506 (illustratively, the vehicle) is not in motion while the communication happens, and communication (e.g., critical software updates, as described in FIG. 6A to FIG. 6C) are only performed while the system 506 is in close proximity of the system 504.

The service system 504 may include an interface module 530 configured to provide an interface between the processing circuit 528 and the optoelectronic component 514 (e.g., configured to “translate” a signal provided by the optoelectronic component 514 into a signal that may be processed by the processing circuit 528). The interface module 530 towards the optoelectronic component 514 may mimic the module 518 at the side of system 506 (e.g., in terms of hardware connection, electrical signal levels and software commands). The interface module 530 towards the processing circuit 528 may provide a common data interface, like USB for data exchange with the processing circuit 528.

The processing circuit 528 (the computer) may be connected through one or more networks 532 (computer networks) with a storage system 534 (e.g., a cloud storage system, for example the cloud of the OEM of the system 506). The cloud 534 may store information 536 specific to the product 502. The information 536 may include the (pre-shared secret) key information 538 of the product 502, as described in further detail below.

FIG. 6A shows the LIDAR device 100 in a schematic view according to various embodiments. In FIG. 6A the exchange (e.g., the transmission and/or the reception) of data via both the standard communication interface 106 and/or via the optical communication interface 108 is illustrated.

In some embodiments, the processing circuit 102 may be configured to receive a request 602 for a software modification. The software modification may include a software modification of the LIDAR device 100. In case the LIDAR device 100 is a LIDAR module, the software modification may be directed to the LIDAR module as a whole (e.g., an update of an operating system of the LIDAR module) or to one of the sub-parts of the LIDAR module (e.g., to a sub-module, or to a component).

The request 602 may include an indication that a system (or a user) external to the LIDAR device 100 (e.g., the service system 300, 504 described in relation to FIG. 3 to FIG. 5) wishes to carry out a software modification on the LIDAR device 100. The request 602 may include details about the software modification to be performed. As an example, the software modification may include an update of a firmware of the LIDAR device 100. In this case, the request 602 may include details about the update, e.g. the number of the new version of the software, who issued the update, a date associated with the update, and the like. As another example, the software modification may include a modification of one or more operational parameters of the LIDAR device 100. In this case, the request 602 may include which operational parameters are to be modified, and how the operational parameters are to be modified. For example, the request 602 may include an indication that a power of emitted light should be increased (e.g., in case the LIDAR device 100 includes a light source), and an indication of the new power level of the emitted light.

The processing circuit 102 may be configured to authenticate the request 602 for software modification via an exchange 604 of authentication data 606 over the standard communication interface 106 and the optical communication interface 108. The authentication of the request 602 for software modification may be understood as the processing circuit 102 being configured to determine whether the request 602 for software modification is legitimate, e.g. whether it has been issued by a trusted source. The authentication may be understood as the processing circuit 102 being configured to determine whether to authorize or reject (in other words, refuse) the request 602 for software modification.

The request 602 for software modification may be issued by a system (e.g., a service system 300, 504) external to the LIDAR device 100 (and in some embodiments external to a system, e.g. a vehicle, including the LIDAR device 100). The LIDAR device 100 and the other system may be coupled with one another over both the standard communication interface 106 and the optical communication interface 108, as described above (see for example FIG. 4 and FIG. 5). For example, the processing circuit of the service system (the processing circuit 308, 528 of the service system 300, 504) may be configured to generate the request 602 for software modification (and to control its transmission to the LIDAR device 100). The use of two interfaces (illustratively, the use of two separate communication channels operating independently from one another) increases the security of the software modification process, reducing or preventing the risk of non-legitimate critical software modifications finding their way into the LIDAR system 100.

The exchange 604 of authentication data 606 will be described in further detail in FIG. 6B and FIG. 6C. Briefly, the processing circuit 102 may be configured to transmit and receive data to decide whether or not to authorize the request 602 for software modification. The authentication data 606 may include any type of data suitable for authenticating the request 602, as described below.

The processing circuit 102 may be configured to exchange 604 authentication data 606 at least in part via the standard communication interface 106. In some embodiments, the processing circuit 102 may be configured to receive the request 602 for software modification over (in other words, via) the standard communication interface 106, e.g. exclusively over the standard communication interface 106 (e.g., the processing circuit 308, 528 of the service system 300, 504 may be configured to transmit the request 602 over the standard communication interface 106), for example over a wired communication interface. In some embodiments, this may ensure that the processing circuit 102 may receive requests for software modification only in presence of a wired connection, which may increase the security of the process (e.g., it may ensure that a vehicle is stationary when receiving the request 602). The reception of the request 602 over a wired communication interface may also ensure that the request 602 comes from outside a system in which the LIDAR device 100 is installed (e.g., from outside a vehicle), thus preventing fake requests from other rogue (e.g., already hacked) modules of the system.

FIG. 6B and FIG. 6C show a schematic representation of an exchange 604 of authentication data (e.g., the authentication data 606) according to various embodiments.

In some embodiments, authentication data (e.g., the authentication data 606) may include an authentication code 608 associated with the received request 602 for software modification. The processing circuit 102 may be configured to generate the authentication code 608, e.g. in response to the received request 602, and may be configured to control a transmission of the authentication code 608. In some embodiments, as shown in FIG. 6B, the processing circuit 102 may be configured to control a transmission of the authentication code 608 over the optical communication interface 108, e.g. via the optoelectronic component 104. The processing circuit 102 may be configured to encode the authentication code 608, and may be configured to control the optoelectronic component 104 (e.g., its light source) to emit a light signal in accordance with the encoded authentication code (as described for example in relation to FIG. 2A). Illustratively, the emitted light signal may include the authentication code. In other embodiments, as shown in FIG. 6C, the processing circuit 102 may be configured to control a transmission of the authentication code 608 over the standard communication interface 108, e.g. in accordance with a communication protocol for wired or wireless communication.

The encoding of the authentication code 608 may be carried out analogically or digitally. As an example, the processing circuit 102 may be configured to encode analog data including the authentication code 608, e.g. a current or a voltage modulated to encode therein the authentication code. As another example, the processing circuit 102 may be configured to encode digital data including the authentication code 608, e.g. a sequence of binary values (e.g., logic 0 and 1) describing the authentication code. The digital data may be used as an instruction to control the optoelectronic component 104.

In some embodiments, the authentication code 608 may include two portions, one (first) portion that is transmitted over the optical communication interface 108, see FIG. 6B (or over the standard communication interface 106, see FIG. 6C), and one (second) portion that is stored for a subsequent comparison with a received response (illustratively, with the received authentication response message 610, described in further detail below). The first portion (referred to herein as sequence) and the second portion (referred to herein as validation code) may be equal to one another. Alternatively, the first portion and the second portion may be different from one another, e.g. the validation code may be a compressed version of the sequence. The validation code may be understood as a check code generated starting from the sequence that may be used to verify the legitimacy of a received response, as described below. Reference herein to the authentication code 608 may be understood to apply to the sequence and to the validation code. Illustratively, the embodiments related to the generation of the authentication code 608 may be understood as related to the generation of a sequence and the associated validation code.

The authentication code 608 may be or may include a unique identifier that the processing circuit 102 may use to determine whether the request 602 is legitimate. The authentication code 608 may prompt a response from the system that issued the request 602 for software modification (e.g., from the service system 300, 504), and the processing circuit 102 may be configured to verify the legitimacy of the request 602 based on the response prompted by the authentication code 608. Illustratively, the authentication data 606 may include an authentication response message 610 associated with the authentication code 608 (e.g., generated in response to the authentication code 608, e.g. by the processing circuit 308, 528 of the service system 300, 504). As an example, the authentication response message 610 may be or may include a response code generated in accordance with the authentication code 608 (e.g., a response code corresponding to the authentication code 608, or generated starting from the sequence in a same manner as the validation code).

By way of illustration, the exchange of authentication data may be described as the processing circuit 102 of the LIDAR device 100 providing an authentication code 608 for authenticating the received request for software modification, and the system that issued the request providing a response code (as authentication response message 610, or part of the authentication response message 610) that matches the authentication code 608. In case the system that issued the request for software modification is a legitimate entity, it will be able to provide a valid response code to respond to the authentication code 608, thus leading to the request for software modification being accepted.

The embodiments described in the following in relation to the generation of the authentication code 608 by the processing circuit 102 may apply also to the generation of the response code by the system that issued the request 602. Illustratively, the processing circuit 308, 528 of the service system 300, 504 may be configured to generate a response code in response to receiving the authentication code 608, and may be configured to generate the response code according to the same scheme (or rules) that the processing circuit 102 of the LIDAR device 100 followed to generate the authentication code 608. The processing circuit 308, 528 of the service system 300, 504 may be configured to generate the authentication response message 610 including the response code and to transmit the authentication response message 610 to the LIDAR device 100. The use of the authentication code 608 and of the authentication response message 610 for authenticating (in other words, validating) the request 602 for software modification will be described in further detail below.

The processing circuit 102 may be configured to generate the authentication code 608 by using information to which a non-legitimate system or user does not have access, thus ensuring that a response matching the authentication code 608 may only be provided by a trusted entity, e.g. the legitimate service system 300. The authentication code 608 may be (uniquely) associated with the LIDAR device 100 (e.g., with the part of the LIDAR device 100 for which the software modification is requested), e.g. the processing circuit 102 may be configured to generate the authentication code 608 by using information associated with the LIDAR device 100. Such information associated with the LIDAR device 100 (also referred to herein as identification information) may be known only to the processing circuit 102 and to a trusted source for the request 602 (e.g., the manufacturer of the LIDAR device 100, a trusted authority, and the like). For example, such information may be stored in a memory of the LIDAR device 100 and in the storage system 310, 534.

In some embodiments, the authentication code 608 (and the response code) may use a random number as part of the identification information. The authentication code 608 (and the response code) may include a random number. As an exemplary implementation, the processing circuit 102 may include a random number generator (not shown) configured to generate the random number. Any suitable approach for generating a random number may be used. As an example, the random number generator may be configured to generate the random number based on temperature information (e.g., based on a temperature of the processing circuit 102, or of the LIDAR device 100). As another example, the random number generator may be configured to generate the random number based on a level of ambient light surrounding the LIDAR device 100. As a further example, the random number generator may be configured to generate the random number based on a level of acoustic noise around the LIDAR device 100. As another example, the random number generator may utilize the current temperature readings from inside the product (the LIDAR device 100).

In some embodiments, additionally or alternatively, the identification information may include information collected by the device (e.g., by the processing circuit 102) during operation, as this information is only known by the device 100, illustratively it is only known inside the device, and is not known by non-legitimate entities. For example, data that was collected over the lifetime of the device 100, e.g. number of light pulses emitted, operating hours (0 Hrs), operating hours during certain conditions, geographical location(s) of the device etc. may be used as identification information. The processing circuit 102 may be configured to generate the authentication code 608 using information collected by the device 100 during operation.

In some embodiments, additionally or alternatively, the identification information may include a-priori known information that is stored within the device, such as an individual serial number of the device, a date of fabrication, etc. The processing circuit 102 may be configured to generate the authentication code 608 using a-prior known information stored in the device 100 (e.g., in a memory of the processing circuit 102).

For example, the identification information may include an individual serial number of the product 100. In particular, an individual serial number may be used as “initial seed” for generating the random number. The serial number may be stored in the LIDAR device 100 at the end of manufacturing process (after passing the final “end test”), e.g. in a non-volatile memory of the LIDAR device 100 (e.g., a non-volatile memory of the processing circuit 102). In addition, the serial number may be known to legitimate sources of request 602 for software modification. For example, the serial number may be stored as part of the product specific information in a cloud owned by the OEM of the LIDAR device 100 (e.g., in the storage system 310, 534). The serial number stored in the LIDAR device 100 may not be modified neither by product internal nor external commands. The serial number (also referred to herein as series number, or as unique product ID) is a number designated to a single unit of a product. Thus, by assigning series numbers, even though products are mass produced and apparently truly identical they are not. For example, the serial number may be printed or engraved on the outside of the LIDAR device 100 (it is not necessary to keep it secret) but it may be accessible to the processing circuit 102 (e.g., an embedded computer) and the access may be read-only (to prevent non-legitimate attempts to modify the serial number).

In some embodiments, the processing circuit 102 may be configured to combine the previously mentioned types of identification information to generate the authentication code 608. The processing circuit 102 may be configured to generate the authentication code by combining the random number and/or the collected information and/or the a-priori known information.

As an example, the authentication code 608 (and the response code) may include the serial number associated with the LIDAR device 100. The processing circuit 102 may be configured to generate the authentication code 608 by combining the random number with the serial number, e.g. by a XOR operation between the random number and the serial number (in other words, by XOR-ing the random number with the serial number). The determination of the authentication code 608 (and of the response code by the other system) may utilize the serial number.

As another example, the authentication code 608 (and the response code) may include lifetime information associated with the LIDAR device 100. The lifetime information may include, for example, a fabrication date of the LIDAR device 100, a number of operating hours of the LIDAR device 100, an installation date of the LIDAR device 100, and the like. The processing circuit 102 may be configured to generate the authentication code 608 by combining the random number with the lifetime information (e.g., with the number of operating hours), e.g. by a XOR operation between the random number and the number of operating hours (in other words, by XOR-ing the random number with the operating hours).

As a further example, the authentication code 608 (and the response code) may include geographical information associated with the LIDAR device 100. The geographical information may include, for example, coordinates (e.g., GPS coordinates) at which the LIDAR device 100 was fabricated, coordinates at which the LIDAR device 100 is currently located, and the like. The processing circuit 102 may be configured to generate the authentication code 608 by combining the random number with the geographical information, e.g. by a XOR operation between the random number and the coordinates at which the LIDAR device 100 is currently located.

In some embodiments, the processing circuit 102 may be configured to generate the authentication code 608 by using a combination of one or more of the information associated with the LIDAR device 100. For example, the processing circuit 102 may be configured to generate the authentication code 608 by concatenating the random number with one or more of the serial number, the number of operating hours, and/or the coordinates at which the LIDAR device 100 is currently located.

In some embodiments, the authentication code 608 may include only the information associated with the LIDAR device 100, illustratively without the random number. The processing circuit 102 may be configured to generate the authentication code 608 by combining with one another (e.g., with a XOR operation) the serial number, the number of operating hours, and/or the coordinates at which the LIDAR device 100 is located.

It is understood that the type of identification information associated with the LIDAR device 100 described herein is exemplary, and other types of information may be used to generate the authentication code 608 (and the response code), e.g. information about an operational parameter of the LIDAR device 100, as another example, as long as it includes information to which an external non-trusted entity does not and cannot have access.

In some embodiments, a scheme according to which the processing circuit 102 generates the authentication code 608 may vary over time (in a same manner as the scheme according to which the other system, e.g. the service system 300, 504 generates the response code), thus introducing an additional layer to the authentication of the request 602. Illustratively, an attacker may not know exactly what scheme is followed for the generation of the authentication code 608, thus preventing the risk that an attacker may generate a false authentication code identical to the genuine one based on previously stolen information.

The selection of the scheme according to which the authentication code 608 is generated may be based on information to which a non-legitimate source does not have access (e.g., on one or more of the identification information described above). As an example, the scheme may be selected based on the lifetime information associated with the LIDAR device 100. Illustratively, the processing circuit 102 may be configured to generate the authentication code 608 in accordance with a generation scheme defined by lifetime information associated with the LIDAR device 100. For example, the determination of the authentication code 608 may utilize the random number, and the scheme on how the code is determined from the random number changes over the life of the product 100. The scheme on how to derive the code may thus, in some embodiments, depend on the lifetime of the product 100. Changing the scheme with the lifetime of the product makes hacking even more difficult.

As an example, in case the LIDAR device 100 has been operating for a number of operating hours below a first threshold (e.g., 500 h) a first generation scheme may be selected (e.g., based on a XOR combination of the random number with one or more of the information associated with the LIDAR device 100). In case the LIDAR device 100 has been operating for a number of operating hours above the first threshold and below a second threshold (e.g., a number of hours between 500 h and 2000 h) a second generation scheme may be selected (e.g., based on a XOR combination of the random number with another information associated with the LIDAR device). In case the LIDAR device 100 has been operating for a number of operating hours above the second threshold, a third generation scheme may be selected (e.g., based on a XOR combination with a yet further information associated with the LIDAR device 100).

It is understood that the generation scheme(s) and the selection strategy described herein are exemplary, and other generation schemes may be provided (with different types of combinations) and other selection criteria may be provided (e.g., different thresholds, or based on different information or parameters associated with the LIDAR device 100).

In some embodiments, the authentication code 608 (and the response code) may be generated by using predefined (e.g., pre-stored) key information shared between the LIDAR device 100 and the system issuing the request 602 for software modification (e.g., the service system 300, 504). The key information may be stored in the LIDAR device 100 (e.g., in a non-volatile memory), and in a storage system to which a trusted source for a software modification has access (e.g., a cloud of the OEM of the LIDAR device 100, e.g., the predefined key information may be stored in the storage system 310, 504).

Illustratively, the processing circuit 102 may be configured to use the shared key information to generate the authentication code 608, and the system that issued the request 602 (e.g., the service system 300, 504 e.g. the processing circuit 308, 528) may use the shared key information to generate the response code. The determination of the authentication code 608 (performed by the product), e.g. of the validation code starting from the sequence, may utilize key information being stored inside the product and the determination of the response code (performed outside of the product), starting from the received sequence, may utilize key information stored outside of the product. For example, the serial number of the LIDAR device 100 may be used as an identifier to retrieve the corresponding key information from the storage system (e.g., from the OEM's cloud) to which a trusted source has access. In an exemplary implementation, at the time when the serial number is programmed into the product, also the key information is generated and stored in the product and at the same time in the OEM's cloud. The shared key information may include, for example, a key to be used as authentication code 608 and as response code. As another example, the shared key information may include a code to be combined with the random number (e.g., with a XOR operation), or with another one of the identification information, to generate the authentication code 608 (and the response code).

The key information is not communicated to any component outside of the LIDAR device 100 (or outside the storage system). The key information is not communicated over any communication channel (e.g. over any of the communication interfaces of the LIDAR device 100, or over any internal communication bus of a vehicle in which the LIDAR device 100 is included, or over any communication channel to and from a cloud of the OEM, as examples). This ensures that the key information cannot be captured by eavesdropping on any communication lines.

In some embodiments, only a part of the key information may be used to determine the authentication code 608. The processing circuit 102 may be configured to generate the authentication code 608 using part (in other words, a subset) of the predefined key information. Analogously, the other system may generate the response code using (the same) part of the predefined key information.

In some embodiments, the shared key information may include a plurality of secret keys, one of which may be selected as authentication code 608 (or selected for combination with one of the identification information) based on a selection criterion, for example a current number of operating hours of the LIDAR device 100.

The used part of the predefined key information may vary over time. Illustratively, the selection of the part of the key information according to which the authentication code 608 (and the response code) may be generated may vary over time. As an example, the used part of the predefined key information may be defined by the lifetime information associated with the LIDAR device 100 (e.g., with the number of operating hours). For example, the key information may include multiple keys, which are used one after the other as the product ages. This may be implemented as a hard switching from one key to another if a certain lifetime criteria is exceeded, or gradually, e.g. as a sliding window over the entire key information where the operating hours determine how far this sliding window is shifted. As another example, the used part of the predefined key information may be defined by the coordinates at which the LIDAR device 100 is located, e.g. a different key may be selected depending on the current coordinates of the LIDAR device 100.

In some embodiments, the shared key information may be different at the side of the LIDAR device 100 and at the side of the service system. The processing circuit 102 may be configured to generate the authentication code 608 using the respective part of the shared key information, and the service system may generate the response code using the respective part of the shared key information.

In some embodiments, the shared key information may allow the service system to verify the authenticity of the LIDAR device 100 (further embodiments regarding the detection of counterfeit will be described in relation to FIG. 8). Illustratively, the service system may expect a certain type of authentication code 608 from the LIDAR device 100, based on the known key information that a genuine LIDAR device should use for generating the authentication code 608. The service system may thus be configured to determine whether the LIDAR device is genuine or counterfeit based on the key information, e.g. based on the received authentication code 608 (e.g., based on a comparison of the received authentication code 608 with an expected authentication code).

The authentication of the request 602 for software modification by using the authentication code 608 and the authentication response message 610 will now be described.

In some embodiments, the processing circuit 102 may be configured to receive the authentication response message 610 and to compare 612 the content of the authentication response message 610 with the generated authentication code 608 (e.g., with the validation code portion). The processing circuit 102 may be configured to receive the authentication response message 610 via one of the standard communication interface 106 or the optical communication interface 108. As a preferred option, the processing circuit 102 may be configured to receive the authentication response message 610 via the standard (e.g., wired) communication interface 106, to provide independent communication of the authentication code 608 and the associated response, as shown in FIG. 6B. However, the processing circuit 102 may alternatively be configured to receive the authentication response message 610 via the optical communication interface 108, e.g. via a modulated light signal, as shown in FIG. 6C. In some embodiments, the processing circuit 102 may be configured to receive the authentication response message 610 via the other communication interface with respect to the one used to transmit the authentication code 608.

Comparing the content of the authentication response message 610 (e.g., the response code) with the generated authentication code 608 may include determining whether the content of the authentication response message 610 corresponds to the authentication code 608, or corresponds to an expected response that the authentication code 608 should have prompted. Illustratively, the comparison 612 may include determining whether the authentication response message 610 (e.g., the response code) corresponds to an expected content (an expected response code) in accordance with the authentication code 608.

The processing circuit 102 may be configured to authorize the request 602 for software modification in accordance with (in other words, based on) the result of the comparison 612. The processing circuit 102 may be configured to authorize (e.g., to accept) the request 602 for software modification (and to implement the software modification) in case the comparison 612 determines that the content of the authentication response message 610 corresponds to the authentication code 608 (or to the expected content in accordance with the authentication code 608). The processing circuit 102 may be configured to reject (in other words, to refuse) the request 602 for software modification in case the comparison 612 determines that the content of the authentication response message 610 does not correspond to the authentication code 608 (or to the expected content).

Stated in a different fashion, according to the approach described herein, a critical software modification may be processed (e.g., carried out) by the product 100 only after a correct security code (the response code) has been provided to the LIDAR module or component (e.g., the component plus device), where the code depends on identification information of the LIDAR device 100 (e.g., a random number, potentially augmented by serial number and lifetime information) which is communicated by the product through an optical communication channel (or, alternatively, through a standard communication channel, as shown in FIG. 6C).

In some embodiments, a mechanism may be implemented to prevent brute force attacks, e.g. attacks based on repeating a non-legitimate request for software modification until the attacker manages to generate a correct response code. The protection mechanism may be based on one or more counters that monitor the number of failed requests and prevent the reception (and the execution) of further requests in case too many (e.g., more than 5, or more than 10) failed attempts have been made. The use of the one or more counters may increase the security of the software modification process.

The processing circuit 102 may be configured, in case the result of the comparison 612 indicates that the content of the authentication response message 610 does not match the authentication code 608 (or the expected content), to modify an error counter (e.g., to increase the error counter by a predefined amount, e.g. by one unit). The error counter may be used to monitor how many wrong authentication response messages have been received in relation to one request for software modification.

The processing circuit 102 may be configured to ignore (in other words, to finally reject or refuse) the request 602 for software modification in case the error counter reaches (e.g., becomes equal to or greater than) a predefined threshold value. After having modified (e.g., increased) the error counter, the processing circuit 102 may be configured to evaluate whether the error counter indicates that too many attempts of providing a correct response code for the present request have been made, and ignore any further attempt associated with that request. The predefined threshold value may be selected according to a balance between providing a secure process (for which it should be as small as possible, e.g. 1) and allowing for errors that may occur in the communication between the LIDAR device 100 and the system issuing the request. As a numerical example, the threshold value for the error counter may be five, or ten.

The processing circuit 102 may be configured to repeat the exchange 604 of authentication data 608 (e.g., the transmission of the authentication code 608 and the reception of the authentication response message 610) in case the error counter has not reached the predefined threshold value. The processing circuit 102 may be configured, after having modified (e.g., increased) the error counter, to evaluate whether the error counter is still less than the predefined threshold value, and (in case it is) allow a further attempt associated with the request 602 for software modification.

The processing circuit 102 may be configured to reset the error counter to an initial value (e.g., 0) in case the request 602 for software modification is authorized (illustratively, in case the request 602 is authorized before the error counter reaches the error threshold value).

In some embodiments, optionally, a further counter may be implemented to take into consideration not only the failed attempts associated with a single request, but also the number of failed consecutive requests. Illustratively, in case an attacker failed to fool the LIDAR device 100 with a first non-legitimate request for software modification, he or she may try again with a further consecutive request (or a plurality of further consecutive requests). The additional counter, referred to herein as request counter, may provide that only a very limited number of failed consecutive requests is allowed before disabling the reception of any further request. This may further increase the security of the software modification process.

The processing circuit 102 may be configured, in case the result of the comparison 612 indicates that the content of the authentication response message 610 does not match the authentication code 608 (or the expected content), to modify a request counter (e.g., to increase the request counter by a predefined amount, e.g. by one unit). The request counter may be used to monitor how many failed (and potentially non-legitimate) consecutive requests for software modification have been received at the LIDAR device 100. Additionally or alternatively, the processing circuit 102 may be configured to modify (e.g., to increase) the request counter in case the error counter has reached its predefined threshold value (also referred to herein as error threshold value).

The processing circuit 102 may be configured to ignore the request 602 for software modification and any further consecutive request for software modification in case the request counter reaches (e.g., is equal to or greater than) a predefined request threshold value. The processing circuit 102 may be configured, after having modified (e.g., increased) the request counter, to evaluate whether the request counter is equal to or greater than the respective threshold value and (in case it is) to disable the reception of any (further consecutive) request for software modification. The request threshold value may be selected according to the same criteria as the error threshold value. As a numerical example, the request threshold value may be one, or two, or five. In case the reception of requests is disabled, the LIDAR device 100 may be brought in a trusted environment (e.g., to a trusted service system, e.g. the service system 300, 504) for further enabling the reception of requests.

The processing circuit 102 may be configured to reset the request counter to an initial value (e.g., 0) in case the request 602 for software modification is authorized (illustratively, in case a request is authorized before the request counter reaches the request threshold value).

In some embodiments, in the case where bi-directional optical communication between the LIDAR device 100 and the service system is available, some of the communication described as occurring over the standard communication interface 106, 302 may be carried out over the optical communication interface 108, 304. Illustratively, a part of the data communication with the LIDAR device 100 may be conducted using the optical path.

In some embodiments, the data for the software modification (following the authentication procedure as described) may be transmitted using the optical path to the product 100. This may be advantageous, for example, in case the data throughput via the optical path is greater than via the standard communication interface (e.g., the wired bus), which may make updates more convenient, as they may be faster and require less waiting for a technician. As another example, it may be advantageous in case not all modules on the bus are “fully trusted” (e.g., it may be a measure of preventing spying from the competition), and hence the confidential code or update information is not passed through other modules and devices or by intra-car buses but rather directly streamed to the product. In addition to the data for software modification transmitted over the optical path, verification information may be transmitted over the standard communication interface, and the software modification may be carried out in case the verification information matches the data for the software modification (illustratively, the update data received over the optical path). An example of update data may include changes to a FLASH memory of the embedded controller internal to the product 100.

In some embodiments, a software modification may be carried out even in case the cloud is not available, e.g. in case the communication between the service station (e.g., the service system 300, 504) and the cloud (the storage system 310, 534) is down. Software modifications that do not involve code deployed from the cloud onto the LIDAR device may be carried out, e.g. software modifications including variations of a few parameters in the product.

As an exemplary implementation, a software modification may be performed and a “NoCloud” countdown counter inside the product may be decreased. In case the counter reaches zero no more update requests before restoring the cloud connection may be accepted by the product. The counter may be, for example, a simple one-bit-counter, hence a single bit, allowing a “not-connected” update only once.

As another exemplary implementation, the software modification may be performed, and a countdown-counter may be set. The countdown counter may be triggered on a regular basis, e.g. by a timer, thereby decreasing the counter while the product is in use (powered). In case the counter reaches a predefined value (e.g., zero), the counter may be kept at the predefined value (at zero). At the next power up the product may not operate anymore, and just generate an error code. In this way the product may only operate for a given number of hours, during which the cloud connection should be established. For example, the owner of the car should return in close proximity of a trusted service system (e.g., the service system 300, 504), for example to a (trusted) garage for completing the service.

FIG. 7 shows a schematic flow diagram of a method 700 of authenticating a request for software modification in a LIDAR device. The flow diagram 700 may describe, for example, the authentication (described in FIG. 6A, FIG. 6B, and FIG. 6C) carried out by the processing circuit 102 of the LIDAR device 100 in relation to the request 602 for software modification.

The method 700 may include, in 702, receiving a request for software (SW) modification (e.g., the request 602) at a LIDAR product (e.g., at the LIDAR device 100). The request may be received via a standard communication interface of the product (e.g., via the wired or radio-based wireless communication interface 106), for example via a bus. As an example, in case of a LIDAR module in a vehicle, the request may be received via the wired intra-car communication bus, e.g. controller area network (CAN) bus. As another example, in case of a LIDAR component (e.g., a component plus product), the request may be received via a serial bus, e.g. an inter-integrated circuit (I2C) bus or a serial peripheral interface (SPI) bus.

The method 700 may include, in 704, generating a random number n (e.g., the processing circuit 102 may generate the random number n). The random number n is generated inside the product. Utilizing a random number may prevent simple “replay attacks”, as a previously valid code is only valid for a single transaction (except for the statistically unlikely case that the same random number is generated again).

The method 700 may include, in 706, computing a sequence S and a validation code V (e.g., computing the authentication code 608). The sequence S may be computed using the random number n. In an exemplary implementation the sequence S is set to be equal to the random number n. In the same step 706 the validation code V may be computed. In an exemplary implementation the validation code is set to be equal to the sequence S. In this case the product may expect to receive the validation code being identical to the sequence S which is being transmitted (e.g., optically) in Step 708. Illustratively, computing the sequence S and the validation code V may be understood as generating the authentication code, and encoding data to be transmitted via the optical communication channel, as shown in FIG. 6B (or via the standard communication interface, as shown in FIG. 6C).

The method 700 may include, in 708, transmitting the sequence via an optical communication channel (e.g., via the optical communication channel 108). In case the LIDAR device includes a light source, the sequence S may be optically transmitted using the product's capability of emitting modulated light (e.g., infrared IR, visible, or ultraviolet UV). In other embodiments, in 708, the method 700 may include transmitting the sequence via a standard communication channel.

The method 700 may include, in 710, waiting and receiving a code C (e.g., a response code prompted by the transmitted sequence S). The code C may be received via the wired communication interface, e.g. via the wired intra-car communication. The code C may be generated and transmitted to the LIDAR device by the system that issued the request for software modification (e.g., the service system 300, 504). Alternatively, the code C may be received via an optical communication channel, as shown in FIG. 6C.

The method 700 may include, in 712, comparing the code C with the previously generated validation code V.

In case both are equal (or in case the code C is equal to an expected response), Yes in 712, then the method 700 may proceed further to 714, where an Error Count counter is reset (to an initial value, e.g. zero), and to 716 where the initially requested software modification is performed (e.g., by the processing circuit 102).

In case code C and validation code V are not identical, No in 712, then the method 700 may include, in 718, increasing the error counter ErrorCount (e.g., by 1).

The method 700 may include, in 720, comparing the error counter ErrorCount with a predefined threshold value, e.g. with a MaxErr constant. MaxErr may be a small number like 10.

In case the ErrorCount is smaller than MaxErr, Yes in 720, then the system resumes its operation by retransmission of the sequence S, illustratively the method 700 may go back to 708 and repeat the transmission of the sequence S.

In case the ErrorCount is not smaller than MaxErr, No in 720, the method 700 may proceed to 722 where the software modification request (received in 702) is ignored.

In order to prevent brute-force-hacking-attacks of the product, another counter (the request counter), SWmodCount, may be added, which counts the number of failed software update requests. Software modification requests may be completely ignored (e.g., indefinitely, remaining for the remaining life of the product) in case the SWmodCount counter reaches a predefined request threshold value, e.g. the constant MaxSWmod. MaxSWmod may be a constant chosen to be a small number, e.g. 5. This provides that at maximum a hacker has MaxSWmod times MaxErr, (e.g., 50 tries using the numerical examples provided above) before the product disables its update functionality.

In order to implement the measure against brute-force-hacking-attacks, the step 704 may be modified to take into account the request counter. The method 700 may include, in modified 704, in case SWmodCount is smaller than MaxSWmod increasing SWmodCount counter by one and generating random number n, otherwise the software modification request is ignored (and the product does nothing). Additionally, the step 714 may be modified including, in addition, resetting the SWmodCount (to an initial value, e.g. to 0).

In some embodiments, the sequence S transmitted in 708 may be received by a LIDAR (receiver) service module of the service system. In other embodiments, the sequence S, or a subset of the sequence S, may be transmitted to the cloud. The response code C may be determined inside the cloud, and then may be communicated back to the processing circuit of the service system (e.g., to the computer of the service system). This communication may be encrypted and authenticated (illustratively, only equipment of authorized dealers can connect to the OEM's cloud).

Additionally or alternatively to the managing of software modification requests, the transmission capabilities of a LIDAR device (e.g., of the LIDAR device loo) may be used for detecting the presence of counterfeits products or components, as described in FIG. 8.

FIG. 8 shows a schematic diagram of the LIDAR device 100 according to various embodiments.

In addition or in alternative to the configuration described in relation to FIG. 6A, FIG. 6B, FIG. 6C, and FIG. 7, the transmission of data over the optical communication interface 108 may be used to transmit information about the LIDAR device 100. Such information may be transmitted, for example, at periodic intervals, or when the LIDAR device 100 sees a system configured to receive (and interpret) the information (e.g., the service system 300, 504). The information may be transmitted in the context of managing a request for software modification, or may be transmitted independently from any request for software modification. The transmitted information may allow determining (at the side of the service system) whether the LIDAR device 100 is a counterfeit product (e.g., in case the transmitted information does not match a predefined or expected information associated with the LIDAR device 100).

The processing circuit 102 may be configured to encode information 802 (also referred to herein as identification information) about the LIDAR device 100, and to control the optoelectronic component 104 to emit a light signal including the encoded information. The processing circuit 102 may be configured to transmit an instruction to the optoelectronic component 104 to emit the light signal modulated to include the encoded information. The encoding of the information 802 may be based on analog or digital encoded data, as described in relation to FIG. 6B for the authentication code 608.

The transmitted information 802 may include, for example, a serial number of the LIDAR device 100, lifetime information associated with the LIDAR device 100 (e.g., a number of operating hours), and/or geographical information associated with the LIDAR device 100 (e.g., current coordinates at which the LIDAR device 100 is located).

As an exemplary implementation, the product (the LIDAR device 100) may transmit its product serial number as well as lifetime information using the optical communication channel on a regular, reoccurring basis (e.g. timer-based, with no “external trigger” needed, for example every hour, or every 5 hours). As another exemplary implementation, the information may be transmitted every time when the random number n is transmitted (e.g., during authentication of a request for software modification, e.g. concatenating the information with the random number, or in other occasions when the random number is transmitted).

The service system (e.g., the service system 300, 504) receiving the information may be configured to determine whether the LIDAR device 100 is a counterfeit LIDAR device based on the received information, e.g. based on the received serial number and/or lifetime information and/or geographical information associated with the LIDAR device 100. The service system may be configured to compare the received information with known (e.g., stored) information (for example stored in the cloud) and determine that the LIDAR device 100 is authentic in case the received information matches the known information (e.g., in case the received serial number corresponds to the known serial number, etc.).

As an exemplary scenario, in case the LIDAR device 100 is installed in a vehicle, every time the vehicle is in the garage, e.g. for service or even just passing by a respective setup elsewhere, e.g. in a car wash, the transmitted serial number and respective lifetime information may be sent to the OEM's cloud in order to verify that the LIDAR device is a genuine part. Thereby a detection of counterfeit (spare) parts is automatically realized.

The transferred lifetime information may be stored in the cloud with the respective serial number. Before the lifetime information is updated in the cloud, it may be checked that the new (newly received) lifetime information refers to a product of same or older age compared to the one on file. By this approach it is ensured, that even if a valid serial number would have been used for the production of counterfeit products, this may still be detected.

Detecting counterfeit products having a valid serial number may also be done without using lifetime information and instead using geographical information combined with time information, to determine whether there are more than a single product having this serial number around. Such an abnormal behavior may be detected by the cloud if a product with a given series number is registered to the cloud within a short time span, so that it would be impossible for the product to be physically relocated from the one position to the other position. Using geographical and time information instead of lifetime information may have some drawbacks. For example, customers may be concerned with respect to being tracked (profiling of how they move around having the respective product with them). As another example, the determination of the product's position may lead to additional effort and/or cost. In case the position information is determined by the product, the product may include respective devices or circuits for determining its location (e.g., GPS or the like), making it more complex, heavier, expensive, etc.

Another option may be augmenting the series number by the location information in the service system receiving the serial number. For example, the service system 300, 504 (e.g., the processing circuit 308, 528) may be configured to augment the received serial number of the LIDAR device 100 with geographical information associated with the LIDAR device 100. The service system may augment the serial number prior to transmitting the information to the storage system (e.g., to the cloud). This may be implemented via manual commissioning effort or respective hardware (e.g. GPS or the like) part of the processing circuit of the service system or the receiver of the service system. The latter approach may ensure that the position is determined automatically, and thus providing an accurate determination even if the system gets physically relocated. This approach is however subject to the capability of the product to receive a geolocation (e.g., it may be an issue inside of buildings). The detection of multiple counterfeit products with identical series numbers may also be less probable, as the detection of an abnormal behavior coming from a counterfeit part requires that two products are registered to the cloud within a short time span, so that it is impossible or very unlikely for the product to be physically relocated between the two locations. Hence the approach only works if many counterfeit products all having an identical series number are around. Nonetheless, the use of geographical information is made possible by the approach described herein.

The processing circuit 102 may be configured to receive a response message representative of an authenticity of the LIDAR device 100 in accordance with the encoded (and emitted) information. The service system may, after having compared the received information with the known information, transmit to the LIDAR device 100 (e.g., via the standard communication interface 106 or the optical communication interface 108) a response message indicating whether the LIDAR device 100 is a genuine or counterfeit product.

As a further embodiment, alternative or additional to the ones describe in relation to FIG. 6A to FIG. 8, the transmission capabilities of the LIDAR device 100 may be “borrowed” by other devices (e.g., another module) that are connected with the LIDAR device 100 (e.g., other devices in a same system, for example in a same vehicle). Illustratively, the other device (e.g., one of the modules 518, 522, 524 described in FIG. 5) may request the LIDAR device 100 to transmit (and optionally receive) data on its behalf, e.g. to communicate with another system (e.g., external to the vehicle). As an example, the other device may request the LIDAR device 100 to transmit proximity authentication data. The proximity authentication data may be used by the requesting device to determine whether it is located in the proximity of a target device or system (e.g., of a service system).

The processing circuit 102 may be configured to receive a request for transmitting proximity authentication data by another device connected with the LIDAR device 100 (e.g., a module 518, 522, 524 connected via a bus 516, 520). The proximity authentication data may include authentication information associated with the device requesting the transmission (e.g., an identifier, lifetime information, etc.). The processing circuit 102 may be configured to generate an instruction to control the optoelectronic component 104 to emit the light signal including the proximity authentication data (illustratively, over the optical communication interface 108).

In an exemplary scenario, the LIDAR device 100 may be configured to provide a “Proximity Authentication Service” to any module (or component or sub-system) on a car. The requesting module may request the LIDAR device to have a communication using its optical path, e.g. a communication with the receiver of a service setup (e.g., with the receiver of the service system 300, 504). If this communication is present (or even ongoing) the requesting module can be sure to be in close proximity to the service setup.

Exemplary applications based on “Proximity Authentication Services” may include: access control applications (e.g. granting access to a parking lot); valet parking applications (e.g., handing over the control of the car to some third party); and/or platooning applications (e.g. regulating the access to some platoon on the highway).

In some embodiments, the LIDAR device 100 may have an active role in the provision of “Proximity Authentication Services”. The LIDAR device 100 may carry out all the steps of the process, e.g. generating the random number, exchanging it optically with the target system, and “reading it back” via standard (e.g., wired) communication. After the data exchange has been completed, the LIDAR device 100 may send a message with the result (e.g., an error code or a confirmation that the random number was received back correctly) to the service requesting device.

In other embodiments, the service requesting device may have a more active role. The device (e.g., any component or module) may send a proximity authentication request to the LIDAR device 100. The request may include a unique address (e.g., a unique bus address) under which the LIDAR device 100 can reach the service requesting device (e.g., when sending the data received via the optical communication interface 108). The LIDAR device 100 (e.g., the processing circuit 102) may be configured to use (e.g., to consult) an internal list of privileges and determine whether the device requesting the service has the permission to request such proxy authentication. The LIDAR device 100 may send (over the bus) a message with the result of this permission check to the unique address of the requesting device. In case the requesting device has the required permission, the requesting device may generate the random number and may transmit the generated random number to the LIDAR device 100. The requesting device may request the LIDAR device 100 to transmit the random number via the optical communication interface 108. The requesting device may, at the same time, send a message to the service system (e.g., to a computer of the service system, e.g. to the processing circuit 308, 528) asking for its support. The requesting device may send the message to the service system over another communication interface, for example over the standard communication interface. The requesting device may request the service system to receive the random number. The computer of the service system may communicate respective details with an interface module (also referred to herein as interface box) of the service system. The computer may receive from the interface box the number optically received from the LIDAR device 100. The computer may then communicate the received number back to the service requesting device. The service requesting device may compare the number originating from the computer with the number that the device initially generated, and make the respective decision.

From the point of view of a service requesting device, it may make sense from a security point of view to utilize the capabilities of the LIDAR device 100 even in case the LIDAR device 100 is not trusted by the service requesting device. There would need to be at least one other rogue component in the communication chain, e.g. another device connected to the bus that may replace the message with a fake message including the number that the service requesting device transmitted over the bus to the LIDAR device 100. Alternatively, the LIDAR device 100 would expose itself to be detected as rogue device (e.g. when a rogue LIDAR device would talk on the bus using the address of a gateway/translator module and transmitting the message to the service requesting device).

Even if the LIDAR device offering the mentioned service would be deemed not trustful by the service requesting device, the service offered would still be valuable in case the random number received is encrypted, e.g. by the computer of the service system, for example with a key only known to the service requesting module and the computer. By this approach even rogue modules on the car or in general in the chain of communication would not be able to trick the service requesting module, as any manipulation of the encrypted message would be detected.

In case the key used by the computer of the service system and by the service requesting module is a pre-shared key, for example stored in the cloud and in the service requesting module, then the key may be provided to the computer from the cloud only using the communication network between cloud and the computer. Thus, the key would not pass through any of the components in the car or the service setup (except for the computer).

The proximity authentication service may be expanded into a secure cloud connection service. The service requesting device may utilize the communication capabilities of the LIDAR device in order to further increase the level of security for its communication by at least partially communicating through an optical channel with the OEM cloud.

In the following, various embodiments of this disclosure will be illustrated. The embodiments may refer to the LIDAR device 100, the service system 300, 504 and the method 700 described above.

Example 1 is a LIDAR device including: a processing circuit configured to: receive a request for a software modification of the LIDAR device; and authenticate the request for software modification via an exchange of authentication data over a standard communication interface and an optical communication interface, the optical communication interface being provided by an optoelectronic component of the LIDAR device.

In Example 2, the LIDAR device of example 1 may optionally further include that the standard communication interface includes one of a wired communication interface or a radio-based wireless communication interface.

In Example 3, the LIDAR device of example 2 may optionally further include that the wired communication interface includes a copper-based communication channel or a fiber-based communication channel.

In Example 4, the LIDAR device of any one of examples 1 to 3 may optionally further include that the optoelectronic component includes a light source configured to emit a light signal, and that the optical communication interface is provided at least in part by a modulation of the light source to provide (e.g., to emit) the light signal.

The light source may include, for example, at least one of an infrared light source, an ultraviolet light source, or a visible light source.

In Example 5, the LIDAR device of any one of examples 1 to 4 may optionally further include that the optoelectronic component includes a sensing element configured to provide a received light signal, and that the optical communication interface is defined at least in part by a demodulation of the light signal received at the sensing element.

In some embodiments, the processing circuit may be configured to receive modification data associated with the software modification over the optical communication interface via the received light signal.

For example, the sensing element may include a photo diode configured to provide a received light signal.

In Example 6, the LIDAR device of examples 4 and 5 may optionally further include that the optoelectronic component includes the light source and the sensing element.

In Example 7, the LIDAR device of any one of examples 1 to 6 may optionally further include that the processing circuit is further configured to determine a time-of-flight associated with a light signal emitted by the optoelectronic component.

In Example 8, the LIDAR device of any one of examples 1 to 7 may optionally further include that the processing circuit is configured to receive the request for software modification over the standard (e.g., wired) communication interface.

In Example 9, the LIDAR device of any one of examples 1 to 8 may optionally further include that the processing circuit is configured to receive the request for software modification by a service system, the service system being coupled with the LIDAR device over the standard communication interface and the optical communication interface.

The coupling over the optical communication interface may be between the optoelectronic component of the LIDAR device and an optoelectronic component of the service system.

In Example 10, the LIDAR device of any one of examples 1 to 9 may optionally further include that the processing circuit is configured to generate an authentication code associated with the received request for software modification and encode the authentication code (e.g., encode analog or digital data including, e.g. representing, the authentication code).

In Example 11, the LIDAR device of example 10 may optionally further include that the processing circuit is configured to generate an instruction to control the optoelectronic component to emit a light signal in accordance with the encoded authentication code (illustratively, in accordance with the analog or digital data representing the authentication code).

In Example 12, the LIDAR device of example 10 or 11 may optionally further include that the authentication code includes a random number.

As an example, the processing circuit may include a random number generator configured to generate the random number. For example, the random number generator may be configured to generate the random number based on temperature information.

In Example 13, the LIDAR device of example 12 may optionally further include that the authentication code further includes at least one of a serial number associated with the LIDAR device, lifetime information associated with the LIDAR device, and/or geographical information associated with the LIDAR device.

In Example 14, the LIDAR device of example 13 may optionally further include that the lifetime information includes a number of operating hours of the LIDAR device.

As an example, the processing circuit may be configured to generate the authentication code by concatenating the random number, the serial number, and the number of operating hours.

In Example 15, the LIDAR device of example 14 may optionally further include that the processing circuit is configured to generate the authentication code by combining the random number with the serial number or by combining the random number with the number of operating hours.

As an example, the combination may include a XOR operation.

In Example 16, the LIDAR device of any one of examples 10 to 15 may optionally further include that the processing circuit is configured to generate the authentication code based on a random number and in accordance with a generation scheme defined by lifetime information associated with the LIDAR device.

In Example 17, the LIDAR device of any one of examples 10 to 16 may optionally further include that the processing circuit is configured to generate the authentication code in accordance with predefined key information, the predefined key information being shared between the LIDAR device and a service system providing the request for software modification.

In Example 18, the LIDAR device of example 17 may optionally further include that the processing circuit is configured to generate the authentication code using at least part of the predefined key information, the used part of the predefined key information being defined by the lifetime information associated with the LIDAR device.

In Example 19, the LIDAR device of any one of examples 1 to 18 may optionally further include that the processing circuit is further configured to generate an instruction to control the optoelectronic component to emit the light signal including lifetime information associated with the LIDAR device.

In Example 20, the LIDAR device of any one of examples 1 to 19 may optionally further include that the processing circuit is further configured to generate an instruction to control the optoelectronic component to emit the light signal including a serial number associated with the LIDAR device.

In Example 21, the LIDAR device of any one of examples 1 to 20 may optionally further include that the processing circuit is configured to receive an authentication response message, and to compare the content of the authentication response message with the generated authentication code.

In Example 22, the LIDAR device of example 21 may optionally further include that the processing circuit is configured to receive the authentication response message via the standard (e.g., wired) communication interface. As an alternative, the processing circuit may be configured to receive the authentication response message via the optical communication interface.

In Example 23, the LIDAR device of example 21 or 22 may optionally further include that the processing circuit is configured to authorize the request for software modification in accordance with the result of the comparison.

In Example 24, the LIDAR device of any one of examples 21 to 23 may optionally further include that the processing circuit is configured, in case the result of the comparison indicates that the content of the authentication response message does not match the authentication code, to modify an error counter, that the processing circuit is further configured to ignore the request for software modification in case the error counter reaches a predefined threshold value, and that the processing circuit is configured to repeat the exchange of authentication data in case the error counter has not reached the predefined threshold value.

In Example 25, the LIDAR device of example 24 may optionally further include that the processing circuit is configured to increase the error counter by one unit in case the result of the comparison indicates that the authentication response message does not match the authentication code, that the processing circuit is configured to repeat the exchange of authentication data in case the error counter is less than the predefined threshold value, and that the processing circuit is configured to ignore the request for software modification in case the error counter is equal to or greater than the predefined threshold value.

In Example 26, the LIDAR device of example 24 or 25 may optionally further include that the processing circuit is configured to reset the error counter to an initial value (e.g., zero) in case the request for software modification is authorized.

In Example 27, the LIDAR device of any one of examples 21 to 26 may optionally further include that the processing circuit is configured, in case the result of the comparison indicates that the content of the authentication response message does not match the authentication code, to modify a request counter, and that the processing circuit is further configured to ignore the request for software modification and any further request for software modification in case the request counter reaches a predefined threshold value.

In Example 28, the LIDAR device of example 27 may optionally further include that the processing circuit is configured to reset the request counter to an initial value in case the request for software modification is authorized.

In Example 29, the LIDAR device of any one of examples 1 to 28 may optionally further include that the software modification includes at least one of a software update and/or a modification of one or more operational parameters of the LIDAR device.

In Example 30, the LIDAR device of any one of examples 1 to 29 may optionally further include that the LIDAR device is or includes one of a LIDAR module or a smart LIDAR component.

In Example 31, the LIDAR device of any one of examples 1 to 30 may optionally further include that the processing circuit is configured to receive a request for transmitting proximity authentication data by another device connected with the LIDAR device, the proximity authentication data including authentication information associated with the device requesting the transmission, and generate an instruction to control the optoelectronic component to emit the light signal including (e.g., in accordance with) the proximity authentication data.

Example 32 is a system including: the LIDAR device of any one of examples 1 to 31, and a service system coupled to the LIDAR device via the standard communication interface and the optical communication interface.

In some embodiments, the processing circuit of the LIDAR device may be configured to generate the authentication code in accordance with predefined key information, the predefined key information being shared between the LIDAR device and the service system.

The service system may be a system configured to test an operation of the LIDAR device (and/or an operation of system, e.g. a vehicle, including the LIDAR device).

In Example 33, the system of example 32 may optionally further include that the service system includes an optoelectronic component (a receiver module) configured to receive the light signal emitted by the optoelectronic component of the LIDAR device over the optical communication interface.

In Example 34, the system of example 32 or 33 may optionally further include that the service system includes a processing circuit configured to generate the request for software modification.

In Example 35, the system of example 34 may optionally further include that the processing circuit is configured to communicate with a network to exchange information associated with the LIDAR device.

In Example 36, the system of example 35 may optionally further include that the information associated with the LIDAR device includes at least one of: predefined key information, a serial number, geographical information and/or lifetime information associated with the LIDAR device.

In Example 37, the system of any one of examples 34 to 36 may optionally further include that the processing circuit is configured to generate an authentication response message in response to receiving the authentication code from the LIDAR device.

In Example 38, the system of any one of examples 34 to 37 may optionally further include that the processing circuit is configured to determine whether the LIDAR device is a counterfeit element based on the received serial number and/or lifetime information associated with the LIDAR device.

Example 39 is a LIDAR device including: a light source configured to emit a light signal; and a processing circuit configured to: encode information about the LIDAR device; transmit an instruction to the light source to emit a light signal in accordance with the encoded information; and receive a response representative of an authenticity of the LIDAR device in accordance with the emitted information.

In Example 40, the LIDAR device of example 39 may optionally further include one, more than one, or all the features of the LIDAR device of any one of the examples 1 to 31.

Example 41 is a method of authenticating a request for a software modification of a LIDAR device, the method including: receiving a request for the software modification of the LIDAR device; and authenticating the request for software modification via an exchange of authentication data over a standard communication interface and an optical communication interface, the optical communication interface being provided by an optoelectronic component of the LIDAR device.

Example 42 is a method of determining the authenticity of a LIDAR device, the method including: transmitting information about the LIDAR device via an optical communication interface, the optical communication interface being provided by an optoelectronic component of the LIDAR device; and comparing the transmitted information with stored (known) information about the LIDAR device.

Example 43 is a vehicle including one or more LIDAR devices according to any one of examples 1 to 31 or 39 to 40.

While various implementations have been particularly shown and described with reference to specific embodiments, it should be understood by those skilled in the art that various changes in form and detail may be made therein without departing from the spirit and scope as defined by the appended claims. The scope is thus indicated by the appended claims and all changes which come within the meaning and range of equivalency of the claims are therefore intended to be embraced.

What is claimed is:

1. A LIDAR device comprising:
a processing circuit configured to:
receive a request for a software modification of the LIDAR device; and
authenticate the request for the software modification via an exchange of authentication data over a standard communication interface and an optical communication interface,
wherein the optical communication interface is provided by an optoelectronic component of the LIDAR device.

2. The LIDAR device according to claim 1, wherein the standard communication interface comprises one of a wired communication interface or a radio-based wireless communication interface.

3. The LIDAR device according to claim 1,
wherein the optoelectronic component comprises a light source configured to emit a light signal, and
wherein the optical communication interface is provided at least in part by a modulation of the light source to provide the light signal.

4. The LIDAR device according to claim 1,
wherein the optoelectronic component comprises a sensing element configured to provide a received light signal, and
wherein the optical communication interface is defined at least in part by a demodulation of the light signal received at the sensing element.

5. The LIDAR device according to claim 1, wherein the processing circuit is further configured to:
generate an authentication code associated with the received request for the software modification;
encode the authentication code; and
generate instructions to control the optoelectronic component to emit a light signal in accordance with the encoded authentication code.

6. The LIDAR device according to claim 5,
wherein the authentication code comprises a random number, and/or
wherein the authentication code comprises at least one of a serial number associated with the LIDAR device, lifetime information associated with the LIDAR device, or geographical information associated with the LIDAR device.

7. The LIDAR device according to claim 1, wherein the processing circuit is further configured to:
receive an authentication response message,
compare a content of the authentication response message with an authentication code, and
authorize the request for the software modification in accordance with a result of the comparison.

8. A system comprising:
the LIDAR device of claim 1; and
a service system coupled to the LIDAR device via the standard communication interface and the optical communication interface.

9. The system according to claim 8, wherein the processing circuit is further configured to generate an authentication code in accordance with predefined key information, the predefined key information being shared between the LIDAR device and the service system.

10. A method for authenticating a request for a software modification of a LIDAR device, the method comprising:
receiving the request for the software modification of the LIDAR device; and
authenticating the request for the software modification via an exchange of authentication data over a standard communication interface and an optical communication interface,
wherein the optical communication interface is provided by an optoelectronic component of the LIDAR device.

11. A method for determining an authenticity of a LIDAR device, the method comprising:
transmitting information about the LIDAR device via an optical communication interface, the optical communication interface being provided by an optoelectronic component of the LIDAR device; and
comparing the transmitted information with stored information about the LIDAR device.

12. A LIDAR device comprising:
a light source configured to emit a light signal; and
a processing circuit configured to:
encode information about the LIDAR device;
transmit an instruction to the light source to emit the light signal in accordance with the encoded information; and
receive a response representative of an authenticity of the LIDAR device in accordance with the emitted information.
